(19) United States
(12) Patent Application Publication
(10) Pub. No.: US 2017/0163374 A1
(43) Pub. Date: Jun. 8, 2017

(54) METHOD AND APPARATUS FOR VERIFICATION

(71) Applicant: FUJITSU LIMITED, Kawasaki-shi (JP)

(72) Inventor: Atsushi Kubota, Yokohama (JP)

(73) Assignee: FUJITSU LIMITED, Kawasaki-shi (JP)

(21) Appl. No.: 15/364,343

(22) Filed: Nov. 30, 2016

(30) Foreign Application Priority Data
Dec. 3, 2015 (JP) 2015-236727

(51) Int. Cl. H04L 1/00; H04L 12/26

(52) U.S. Cl. CPC H04L 1/0002; H04L 43/0858; H04L 12/2854

(57) ABSTRACT

A disclosed verification method includes: capturing data transmitted to a first site from a node; emulating conversion of the captured data; measuring a conversion time; calculating a first transmission time in a case where the captured data is assumed to be transmitted from the node to a conversion apparatus, a second transmission time in a case where the converted data is assumed to be transmitted from the conversion apparatus to the node, a third transmission time in a case where the converted data is assumed to be transmitted from the node to the first site, and a fourth transmission time in a case where the captured data is assumed to be transmitted from the node to the first site; and determining an effect in a case where the conversion by the conversion apparatus is applied, based on the first to fourth transmission times and the conversion time.

### CROSS-REFERENCE TO RELATED APPLICATIONS

This application is based upon and claims the benefit of priority of the prior Japanese Patent Application No. 2015-236727, filed on Dec. 3, 2015, the entire contents of which are incorporated herein by reference.

### FIELD

This invention relates to a technique for verifying an effect of converting communication data.

### BACKGROUND

For example, there is a technique related to data transmission in a path that connects two LAN (Local Area Networks) sites through a WAN (Wide Area Network), and that reduces an amount of communication data by compressing data and eliminating duplication. Reducing the amount of communication data shortens a transmission time.

However, this kind of communication data conversion does not always make an expected effect. Therefore, there are cases where the effect of communication data conversion is estimated in advance. In order to more accurately estimate the effect, it is preferable to actually perform communication data conversion and measurement.

However, in a system that is in operation, the work of switching transmission paths in order to apply communication data conversion is complicated. Moreover, in the case of a system in which continuous operation is required, there are times when transmission paths stay not be switched.

Patent Document 1: Japanese Laid-open Patent Publication No. 2006-011683

Patent Document 2: Japanese Laid-open Patent Publication No. 06-223011

Patent Document 3: Japanese Laid-open Patent Publication No. 2002-268937

Patent Document 4: Japanese Laid-open Patent Publication No. 2010-141515

Patent Document 5: Japanese Laid-open Patent Publication No. 2009-271602

In other words, there is no technique for verifying an effect of communication data conversion applied in a system that is in operation.

### SUMMARY

A verification method related to an aspect includes: (A) capturing communication data transmitted to a first site, from a node apparatus that is in a second site and is assumed to be connected to a conversion apparatus that performs conversion of communication data; (B) emulating the conversion of the captured communication data; (C) measuring a conversion time required for the conversion of the captured communication data; (D) calculating a first transmission time in a case where the captured communication data is assumed to be transmitted from the node apparatus to the conversion apparatus; (E) calculating a second transmission time in a case where converted communication data is assumed to be transmitted from the conversion apparatus to the node apparatus; (F) calculating a third transmission time in a case where the converted communication data is assumed to be transmitted from the node apparatus to the first site; (G) calculating a fourth transmission time in a case where the captured communication data is assumed to be transmitted from the node apparatus to the first site; and (H) determining an effect in a case where the conversion of the captured communication data by the conversion apparatus is applied, based on the first transmission time, the conversion time, the second transmission time, the third transmission time and the fourth transmission time.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OP DRAWINGS

FIG. 1 is a diagram depicting an example of a configuration of a network between sites when communication data conversion is not applied;

FIG. 2 is a diagram depicting an example of a configuration of a network between sites when communication data conversion is applied;

FIG. 3 is a diagram depicting an outline of conversion processing of communication data;

FIG. 4 is a diagram depicting an example of a configuration of a network between sites in embodiments;

FIG. 5 is a diagram depicting an example of a configuration of modules in a verification apparatus;

FIG. 6 is a diagram depicting an example of a configuration of a service table;

FIG. 7 is a diagram depicting an example of a configuration of a conversion log;

FIG. 8 is a diagram depicting an example of a configuration of an assessment table;

FIG. 9 is a diagram depicting a processing flow of main processing;

FIG. 10 is a diagram depicting an example of a configuration of rate data;

FIG. 11 is a diagram depicting a processing flow of measurement processing;

FIG. 12 is a diagram depicting a processing flow of first subroutine processing (A);

FIG. 13 is a diagram depicting a processing flow of conversion processing (A);

FIG. 14 is a diagram depicting a processing flow of second subroutine processing (A);

FIG. 15 is a diagram depicting a processing flow of third subroutine processing;

FIG. 16 is a diagram depicting a processing flow of determination processing (A);

FIG. 17 is a diagram depicting an example of a configuration of a session table;

FIG. 18 is a diagram depicting a processing flow of first subroutine processing (B);

FIG. 19 is a diagram depicting a processing flow of second subroutine processing (B);

FIG. 20 is a diagram depicting a processing flow of determination processing (B);

FIG. 21 is a diagram depicting an example of a configuration of a conversion log in a third embodiment;

FIG. 22 is a diagram depicting a processing flow of determination processing (C);

FIG. 23 is a diagram depicting a processing flow of determination processing (D);

FIG. 24 is a diagram depicting a processing flow of determination processing (E);

FIG. 25 is a diagram depicting a processing flow of determination processing (F);

FIG. 26 is a diagram depicting a processing flow of determination processing (G);

FIG. 27 is a diagram depicting a processing flow of determination processing (H);

FIG. 28 is a diagram depicting a processing flow of determination processing (I);

FIG. 29 is a diagram depicting a processing flow of determination processing (J);

FIG. 30 is a diagram depicting an example of a configuration of an assessment table in an eleventh embodiment;

FIG. 31 is a diagram depicting an example of a first frequency distribution table;

FIG. 32 is a diagram depicting an example of a first histogram;

FIG. 33 is a diagram depicting an example of a second frequency distribution table;

FIG. 34 is a diagram depicting an example of a second histogram;

FIG. 35 is a diagram depicting an example of a third frequency distribution table;

FIG. 36 is a diagram depicting an example of a third histogram;

FIG. 37 is a diagram depicting an example of a fourth frequency distribution table;

FIG. 38 is a diagram depicting an example of a fourth histogram;

FIG. 39 is a diagram depicting an example of a fifth frequency distribution table;

FIG. 40 is a diagram depicting an example of a fifth histogram;

FIG. 41 is a diagram depicting an outline of conversion processing for communication data in a thirteenth embodiment;

FIG. 42 is a diagram depicting a processing flow of conversion processing (B);

FIG. 43 is a diagram depicting an outline of conversion processing for communication data in a fourteenth embodiment; and

FIG. 44 is a functional block diagram of a computer.

### DESCRIPTION OF EMBODIMENTS

### Embodiment 1

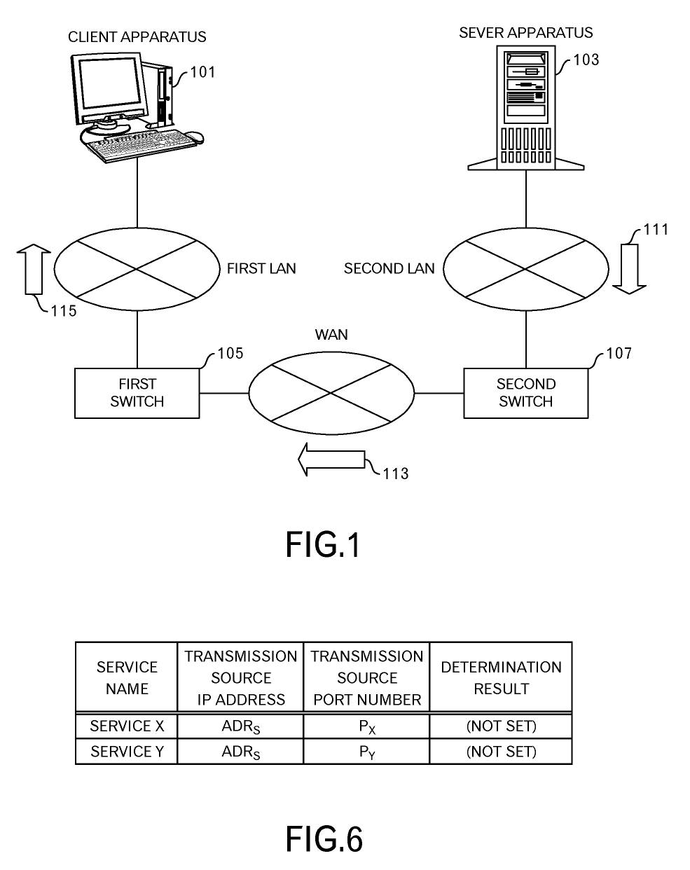

FIG. 1 illustrates an example of configuration of network between sites when communication data conversion is not applied. In this example, two sites are connected by a WAN. At one site, a client apparatus 101 is connected to a first LAN. At the other site, a server apparatus 103 is connected to a second LAN. In this example, it is assumed that the client apparatus 101 uses the service of the server apparatus 103. The apparatus connected to the first LAN may also be a server apparatus that uses the service of a server apparatus 103.

In this example, attention is paid to messages that are sent from the server apparatus 103 to the client apparatus 101. As illustrated by the arrow 111, first, a message is sent to the second switch 107 by way of the second LAN. Next, as illustrated by the arrow 113, the message is sent to the first switch 105 by way of the WAN. Then, as illustrated by the arrow 115, the message is sent to the client apparatus 101 by way of the first LAN.

Performance in a case where performing data communication between sites that are connected by a WAN in this way often relies on the communication speed of the WAN. Therefore, in order to reduce communication traffic of the WAN, a relay apparatus that performs communication data conversion may be provided.

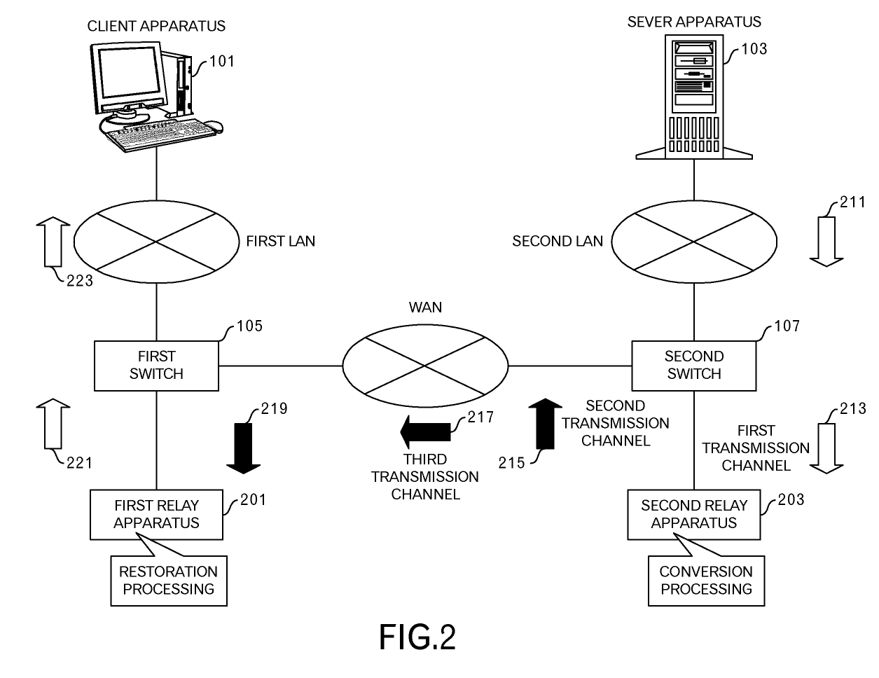

FIG. 2 illustrates an example of a configuration of a network between sites when communication data conversion is applied. In this example, as illustrated by the arrow 211, a message that was sent from the server apparatus 103 to the second switch 107 is transferred to a second relay apparatus 203 as illustrated by the arrow 213.

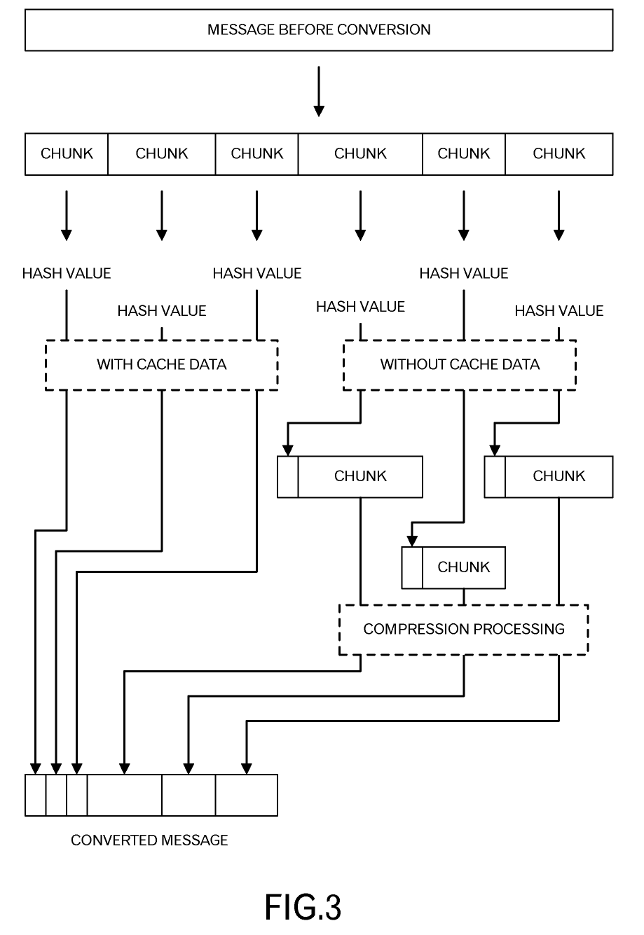

The second relay apparatus 203 performs conversion processing on the message. FIG. 3 illustrates a summary of the conversion processing for communication data. The second relay apparatus 203 reduces an amount of communication data by removing duplicated areas that are included in the message. Moreover, the second relay apparatus 203 reduces an amount of communication data by compressing data in an unduplicated area.

More specifically, the second relay apparatus 203 divides the message into chunks. In FIG. 3, the start of the message is on the left side. A hash function is applied to each chunk, and hash values are calculated. A hash value is used as an index in a cache. When a chunk is cached, the index is added to the converted message instead of the chunk.

On the other hand, when a chunk is not cached, the index is attached to the chunk as a header, and compression processing is performed on chunks with headers. And the compressed data is added to the converted message.

Returning to the explanation of FIG. 2, as illustrated by the arrow 215, the converted message is returned to the second switch 107. Then, as illustrated by the arrow 217, the converted message is sent to the first switch 105 by way of the WAN.

As illustrated by the arrow 219, the first switch 105 transfers the converted message to the first relay apparatus 201. The first relay apparatus 201 performs restoration processing on the converted message, and restores the message to the state before conversion. As illustrated by the arrow 221, the first relay apparatus 201 returns the message that has been restored to the state before conversion to the first switch 105. As illustrated by the arrow 223, the first switch 105 sends the message in the state before conversion to the destination client apparatus 101.

In FIG. 2, the path by which the converted message is transferred is illustrated by filled-in arrows. When compared with the case illustrated in FIG. 1, transmission illustrated by the arrow 213 increases. The transmission path that is illustrated by the arrow 213 is called the first transmission channel. Similarly, the transmission illustrated by the arrow 215 increases. The transmission path that is illustrated by the arrow 215 is called the second transmission channel. Moreover, in the transmission illustrated by the arrow 217, the size of the data has become small. Hereafter, this path will be called the third transmission channel in both the case in which communication data conversion is applied, and the case in which communication data conversion is not applied.

In this embodiment, attention is paid to the transmission time over the first transmission channel to the third transmission channel, and to the time of the conversion processing at the second relay apparatus 203, and the effect of applying communication data conversion is verified.

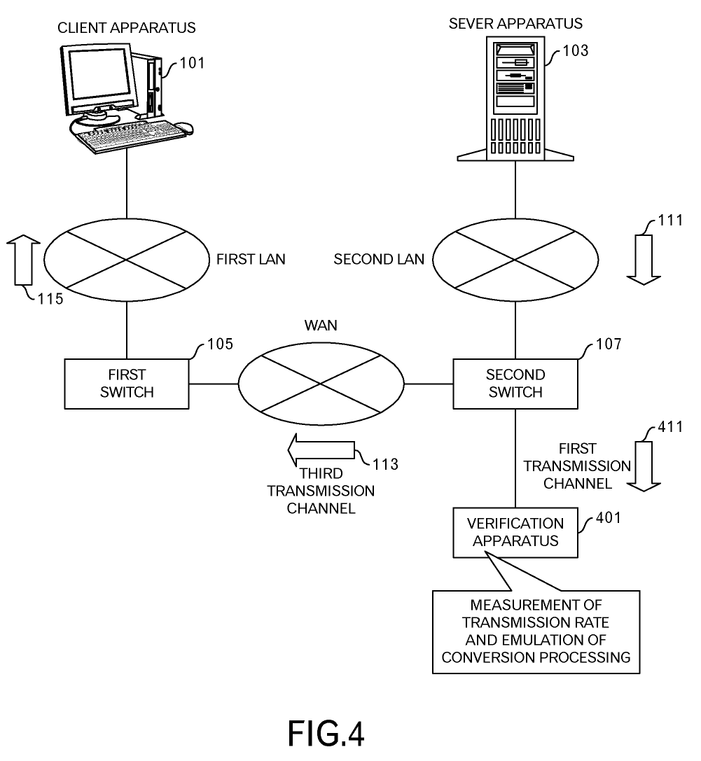

In this embodiment, a verification apparatus is used in order to verify the effect of applying communication data conversion, while maintaining the form of data transmission illustrated in FIG. 1. FIG. 4 illustrates an example of a configuration of a network between sites in this embodiment. The verification apparatus 401 is connected to the second switch 107. In other words, the verification apparatus 401 is connected in the same way as the second relay apparatus 203.

As illustrated by the arrow 411, the verification apparatus 401 captures a message from the second switch 107. The verification apparatus 401 emulates the conversion processing the captured message, which is perforated by the second relay apparatus 203, and calculates a conversion time and a size of the converted message. Moreover, the verification apparatus 401 measures the transmission rates over the first transmission channel to the third transmission channel. Then, based on this data, the verification apparatus 401 calculates a difference between the time required for the case in which communication data conversion is applied and the case in which communication data conversion is not applied. Furthermore, the verification apparatus 401 calculates a reduction rate of data. The explanation of an outline of this embodiment is ended here.

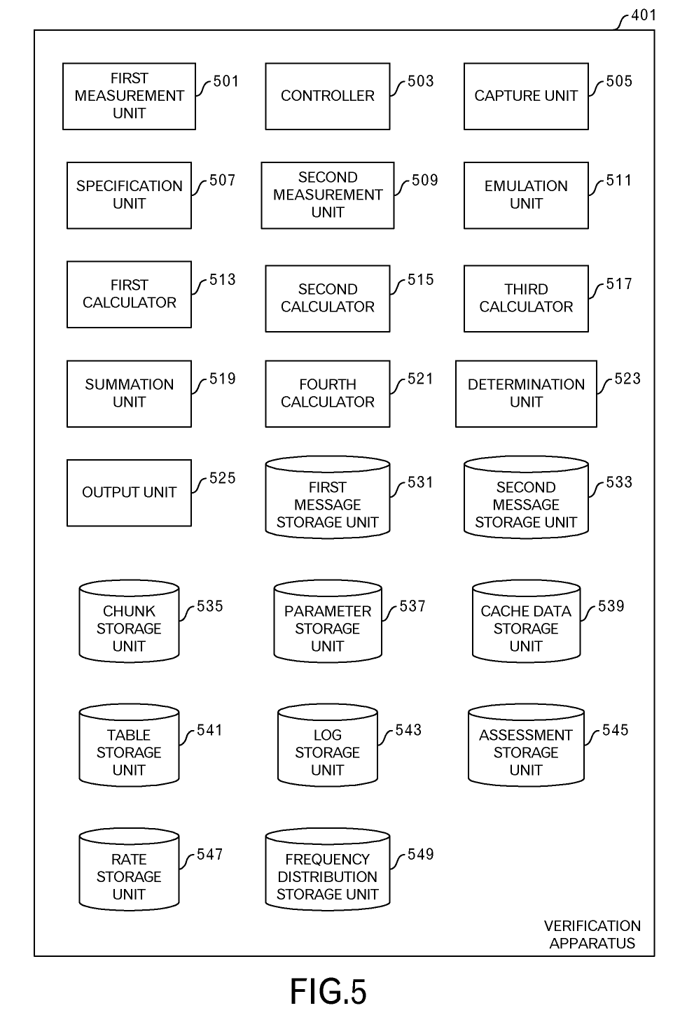

FIG. 5 illustrates an example of a configuration of modules of the verification apparatus 401. The verification apparatus 401 includes a first measurement unit 501, a controller 503, a capture unit 505, a specification unit 507, a second measurement unit 509, an emulation unit 511, a first calculator 513, a second calculator 515, a third calculator 517, a summation unit 519, a fourth calculator 521, a determination unit 523 and an output unit 525.

The first measurement unit 501 measures each transmission rate. The controller 503 controls a flow of processing by the verification apparatus 401. The capture unit 505 captures, by way of the second switch 107, messages that flow between the second LAM and the WAN. The specification unit 507 specifies a size of a message before conversion. The second measurement unit 509 measures a time of the conversion processing. The emulation unit 511 emulates the conversion processing in relay processing. The first calculator 513 calculates a first transmission time. The first transmission time is a transmission time of a message before conversion on the first transmission channel. The second calculator 515 calculates a second transmission time. The second transmission time is a transmission time of a converted message on the second transmission channel. The third calculator 517 calculates a third transmission time. The third transmission time is a transmission time for a converted message on the third transmission channel. The summation unit 519 calculates a total time of the first transmission time, the conversion time, the second transmission time and the third transmission time. The fourth calculator 521 calculates a fourth transmission time. The fourth transmission time is a transmission time of a message in the state before conversion on the third transmission channel. The determination unit 523 determines whether the effect of communication data conversion is large or small. The output unit 525 outputs the determination result. The first transmission time to the fourth transmission time are estimated values for transmission times when it is assumed that the second relay apparatus 203 is connected and operated.

The first measurement unit 501, the controller 503, the capture unit 505, the specification unit 507, the second measurement unit 509, the emulation unit 511, the first calculator 513, the second calculator 515, the third calculator 517, the summation unit 519, the fourth calculator 521, the determination unit 523 and the output unit 525 described above are achieved by using hardware resources (for example, refer to FIG. 44) and a program that causes a processor to execute processing that will be described below.

The verification apparatus 401 further includes a first message storage unit 531, a second message storage unit 533, a chunk storage unit 535, a parameter storage unit 537, a cache data storage unit 539, a table storage unit 541, a log storage unit 543, an assessment storage unit 545, a rate storage unit 547 and a frequency distribution storage unit 549.

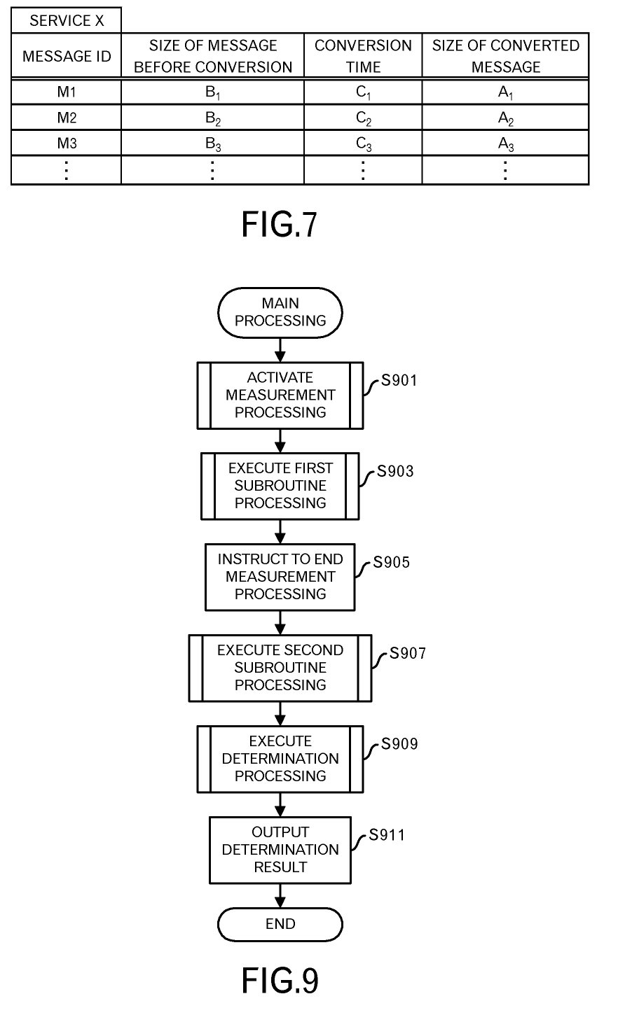

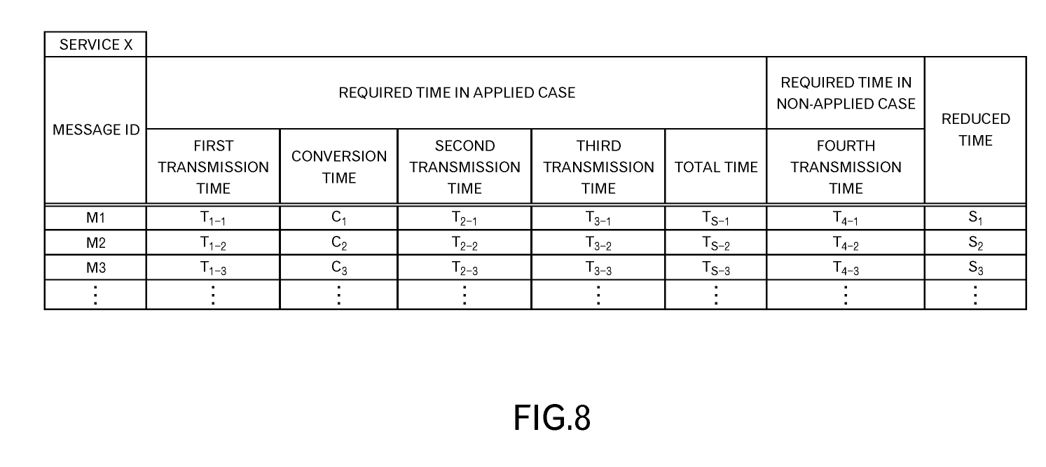

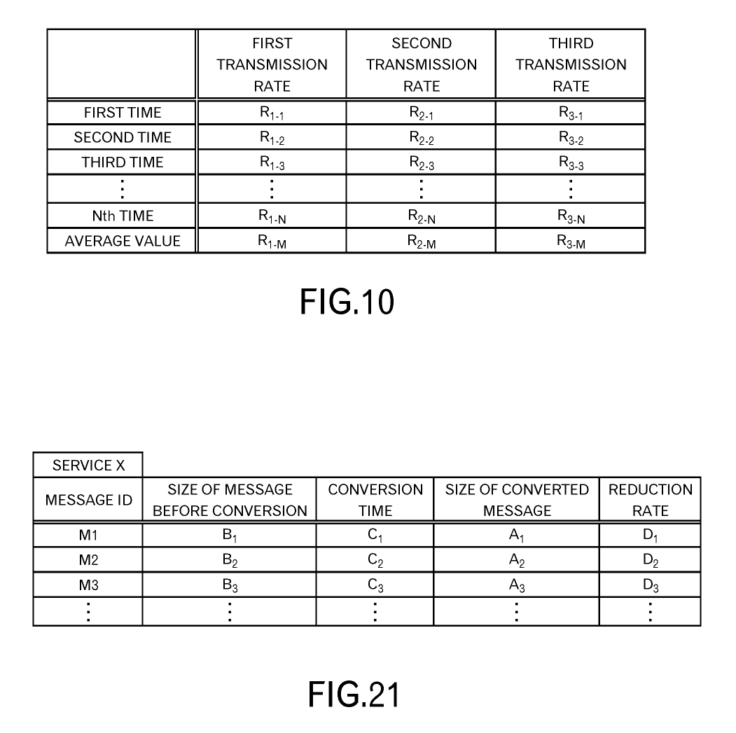

The first message storage unit 531 stores a message before conversion. The second message storage unit 533 stores a converted message. The chunk storage unit 535 temporarily stores divided chunks. The parameter storage unit 537 temporarily stores various kinds of parameters. The cache data storage unit 539 has a cache area for storing chunks. Moreover, the cache data storage unit 539 also has an area for storing a hash table in which indices are set. The table storage unit 541 stores a service table. In the service table, data related to a service that is the target of verification is set. The service table will be described later using FIG. 6. In the embodiment described below, the table storage unit 541 stores a session table. The log storage unit 543 stores a conversion log. In the conversion log, data related to the conversion processing is set. The conversion log will be described later using FIG. 7. The assessment storage unit 545 stores an assessment table. In the assessment table, assessment data related to processing of each message are set. The assessment table will be described later using FIG. 8. The rate storage unit 547 stores rate data. The rate data includes each transmission rate. The rate data will be described later using FIG. 10. The frequency distribution storage unit 549 stores various kinds of frequency distribution tables. The frequency distribution tables will be explained in the embodiments to be described.

The first message storage unit 531, the second message storage unit 533, the chunk storage unit 535, the parameter storage unit 537, the cache data storage unit 539, the table storage unit 541, the log storage unit 543, the assessment storage unit 545, the rate storage unit 547 and the frequency distribution storage unit 549 described above are achieved by using hardware resources (for example, refer to FIG. 44).

FIG. 6 illustrates an example of a configuration of a service table. The service table in this example has records that correspond to services that are the targets of verification (hereafter, these are called service records).

A service record has a field for setting the service name, a field for setting the transmission-source IP (Internet Protocol) address, a field for setting the transmission-source port number, and a field for setting a determination result.

The service name identifies a service that is the target of verification. The transmission-source IP address is an IP address of an apparatus that provides the service that is the target of verification. The transmission-source port number is a port number that is used by the service that is the target of verification. The determination result represents whether an effect when communication data conversion was applied to the service that is the target of verification is large or small. In the service table, data other than the determination result are set beforehand.

In the first service record illustrated in FIG. 6, “service X” that is provided by an apparatus having a transmission-source IP address “ADR_{S}” and using a port number “P_{X}” is the target of verification. In this example, the determination result has not yet been set.

Similarly, in the second service record illustrated in FIG. 6, “service Y” that is provided by an apparatus having a transmission-source IP address “ADR_{S}” and using a port number “P_{Y}” is the target of verification. In this example, also the determination result has not yet been set.

FIG. 7 illustrates an example of a configuration of a conversion log. A conversion log is provided for each service. In an embodiment to be described later, a conversion log is provided for each session. The conversion log of this example is in the form of a table. However, the conversion log may be in a form other than a table. The conversion log in this example has records that correspond to conversion processing performed once (hereafter, these will be called conversion records).

The conversion record has a field for setting a message ID, a field for setting a size of a message before conversion, a field for setting a conversion time, and a field for setting a size of a converted message. The message ID identifies a message that is the target of conversion. The size of a message before conversion is a Size of a message that has become the target of conversion. The conversion time is an amount of time required for the conversion processing for the message. The size of a converted message is a size of a message which is the conversion result.

The conversion log in this example corresponds to “service X”. The first conversion record illustrated in FIG. 7 represents that an amount of time “C₁” is required for the conversion processing for a message identified by the message ID “M1”, and that the message size has changed from “B₁” to “A₁”.

Similarly, the second conversion record represents that an amount of time “C₂” is required for the conversion processing for a message identified by the message ID “M2”, and that the message size has changed from “B₂” to “A₂”.

Similarly, the third conversion record represents that an amount of time “C₃” is required for the conversion processing for a message identified by the message ID “M3”, and that the message size has changed from “B₃” to “A₃”.

FIG. 8 illustrates an example of a configuration of an assessment table. The assessment table is provided for each service. In an embodiment to be described later, the assessment table is provided for each session.

The assessment table of this example has records corresponding to a message (hereafter, called assessment records). An assessment record has a field for setting a message ID, a field for setting the first transmission time, a field for setting the conversion time, a field for setting the second transmission time, a field for setting the third transmission time, a field for setting the total time, a field for setting the fourth transmission time, and a field for setting the reduced time.

The message ID identifies a message that is the target of assessment. The conversion time in the assessment table is equivalent to the conversion time in the conversion log. The total of the first transmission time, the conversion time and the second transmission time corresponds to an overhead time. The total time is the total of the overhead time and the third transmission time. In other words, the total time is the total of the first transmission time, the conversion time, the second transmission time and the third transmission time. The total time in the case where communication data conversion is applied is the amount of time required from the point in time when the second switch 107 received the message before conversion to the point in time when the converted message is transferred to the first switch 105 (hereafter, this is called the required time in the applied case).

The fourth transmission time is, in the case where communication data conversion is not applied, an amount of time required from the point in time when the second switch 107 received the message before conversion to the point in time when that message before conversion is transferred to the first switch 105 (hereafter, this is called the required time in the non-applied case).

The reduced time is the time estimated to be reduced by applying communication data conversion. More specifically, a value obtained by subtracting the fourth transmission time from the total time is the reduced time.

The assessment table in this example corresponds to “service X”. The first assessment record in FIG. 8 represents that in the case where communication data conversion is applied to the message identified by the message ID “M1”, an amount of time “T₁₋₁” is required for transmitting the message over the first transmission channel, and an amount of time “C₁” is required for converting that message. Moreover, that record represents that an amount of time “T₂₋₁” is required for transmitting the converted message over the second transmission channel, and similarly represents that an amount of time “T₃₋₁” is required for transmitting the converted message over the third transmission channel. Furthermore, that record represents that the total of the time “T₁₋₁”, time “C₁”, the time “T₂₋₁” and the time “T₃₋₁” is the time “T_{S-1}”. That record further represents that in the case where communication data conversion is not applied, an amount of time “T₄₋₁” is required to transmit the message identified by the message ID “M1” over the third transmission channel. The record represents that the time is estimated to be reduced by an amount of time “S₁” by applying communication data conversion.

Similarly, the second assessment record represents that in the case where communication data conversion is applied to the message identified by the message ID “M2”, an amount of time “T₁₋₂” is required for transmitting the message over the first transmission channel, and an amount of time “C₂” is required for converting that message. Moreover, that record represents that an amount of time “T₂₋₂” is required for transmitting the converted message over the second transmission channel, and similarly represents that an amount of time “T₃₋₂” is required for transmitting the converted message over the third transmission channel. Furthermore, that record represents that the total of the time “T₁₋₂”, time “C₂”, the time “T₂₋₂” and the time “T₃₋₂” is the time “T_{S-2}”. That record further represents that in the case where communication data conversion is not applied, an amount of time “T₄₋₂” is required to transmit the message identified by the message ID “M2” over the third transmission channel. The record represents that the time is estimated to be reduced by an amount of time “S₂” by applying communication data conversion.

Similarly, the third assessment record represents that in the case where communication data conversion is applied to the message identified by the message ID “M3”, an amount of time “T₁₋₃” is required for transmitting the message over the first transmission channel, and an amount of time is “C₃” required for converting that message. Moreover, that record represents that an amount of time “T₂₋₃” is required for transmitting the converted message over the second transmission channel, and similarly represents that an amount of time “T₃₋₃” is required for transmitting the converted message over the third transmission channel. Furthermore, that record represents that the total of the time “T₁₋₃”, time “C₃”, the time “T₂₋₃” and the time “T₃₋₃” is the time “T_{S-3}”. That record further represents that in the case where communication data conversion is not applied, an amount of time “T₄₋₃” is required to transmit the message identified by the message ID “M3” over the third transmission channel. The record represents that the time is estimated to be reduced by the amount of time “S₃” by applying communication data conversion.

Next, processing by the verification apparatus 401 will be explained. FIG. 9 illustrates a processing flow of main processing by the verification apparatus 401. The controller 503 activates the measurement processing by the first measurement unit 501 (S901). In the measurement processing, the first measurement unit 501 measures each transmission rate. The measurement processing is executed in parallel with the main processing.

Before explaining the measurement processing, the rate data, which is the measurement result of measurement processing, will be explained. FIG. 10 illustrates an example of a configuration of rate data. The rate data in this example is in the form of a table. However, the rate data may also be in a form other than the form of a table. The rate data in this example has records that correspond to the time in which measurement is performed, and records for setting an average (hereafter, called rate records).

A rate record has a field for setting the first transmission rate, a field for setting the second transmission rate, and a field for setting the third transmission rate. The first transmission rate is a transmission rate over the first transmission channel. The second transmission rate is a transmission rate over the second transmission channel. The third transmission rate is a transmission rate over the third transmission channel.

In the example illustrated in FIG. 10, an average value for the first transmission rate “R₁₋₁” that is measured the first time to the first transmission rate “R_{1-N}” that is measured the Nth time is illustrated as being “R_{1-N}”. Similarly, an average value for the second transmission rate “R₂₋₁” that is measured the first time to the second transmission rate “R_{2-N}” that is measured the Nth time is illustrated as being “R_{2-N}”. Similarly, an average value for the third transmission rate “R₃₋₁” that is measured the first time to the third transmission rate “R_{3-N}” that is measured the Nth time is illustrated as being “R_{3-N}”.

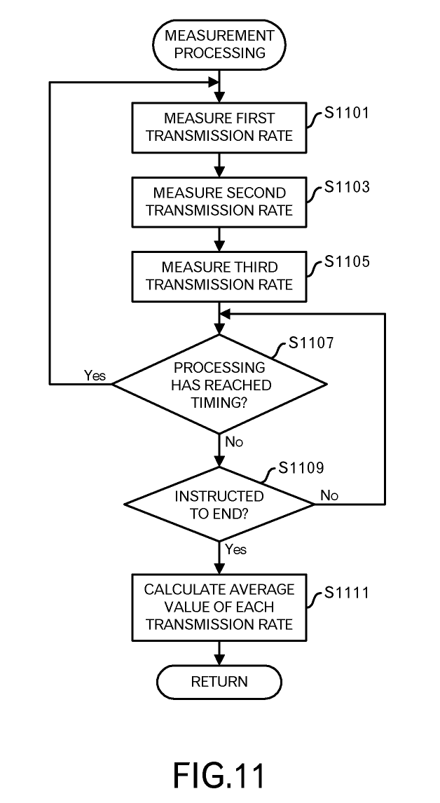

FIG. 11 illustrates the flow of the measurement processing. The first measurement unit 501 measures the first transmission rate (S1101). The first measurement unit 501 could also be such that the first transmission rate is obtained from the second switch 107. The first measurement unit 501 then sets the measured first transmission rate in a record corresponding to that measurement time.

The first measurement unit 501 measures the second transmission rate (S1103). The first measurement unit 501 may also obtain the second transmission rate from the second switch 107. The first measurement unit 501 then sets the measured second transmission rate in a record corresponding to that measurement time.

The first measurement unit 501 measures the third transmission rate (S1105). The first measurement unit 501 may also obtain the third transmission rate from the second switch 107. The first measurement unit 501 then sets the measured third transmission rate in a record corresponding to that measurement time.

The first measurement unit 501 determines whether or not the processing has reached the timing to perform the next measurement (S1107). The first measurement unit 501 repeats measurement in a specified cycle, for example. When it is determined that the processing has not reached that timing, the first measurement unit 501 determines whether or not there was an end instruction from the controller 503 (S1109).

When it is determined that there is not an end instruction, the processing returns to the processing illustrated as S1107, and the processing described above is repeated. In S1107, when it is determined that the processing has reached the timing, the processing returns to S1101, and the processing described above is repeated.

In S1109, when it is determined that there is an end instruction, the first measurement unit 501 calculates an average value for each transmission rate (S1111). The first measurement unit 501 then sets the average value for each transmission rate in a record for setting the average values.

The explanation now returns to the explanation of FIG. 9. After the measurement processing has been activated, without waiting for the end of the measurement processing, the controller 503 executes a first subroutine processing (S903). In this embodiment, the controller 503 executes a first subroutine processing (A).

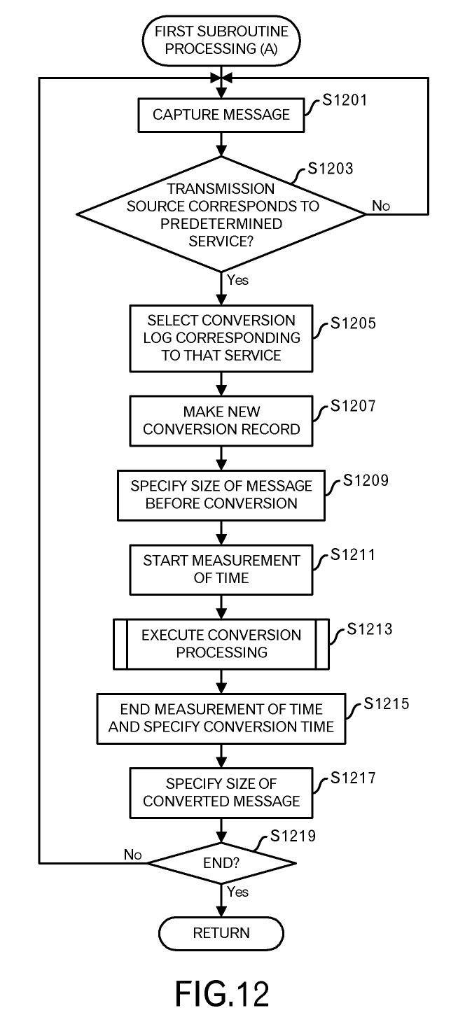

FIG. 12 illustrates a processing flow of the first subroutine processing (A). The capture unit 505, by way of the second switch 107, captures a message that flows between the second LAN and the WAN (S1201).

The controller 503 determines whether or not the transmission source of the captured message corresponds to a predetermined service (S1203). More specifically, when the IP address of the transmission source and the port number of the transmission source that are set in the captured message coincide with a combination of an IP address of a transmission source and a port number of a transmission source that is set in any of the service records, the controller 503 determines that the transmission source of the message corresponds to the predetermined service.

When it is determined that the transmission source of the captured message does not correspond to the predetermined service, the processing returns to the processing illustrated in S1201, and the processing described above is repeated.

On the other hand, when it is determined that the transmission source of the captured message corresponds to a predetermined service, the controller 503 selects a conversion log that corresponds to that service (S1205). The controller 503 then makes a new conversion record in the selected conversion log (S1207).

The specification unit 507 specifies a size of the captured message, or in other words, the message before conversion (S1209). The specification unit 507 then sets the specified size of the message before conversion in the new conversion record.

The second measurement unit 509 starts measurement of time (S1211), and the emulation unit 511 executes the conversion processing (S1213). In the conversion processing, the emulation unit 511, in the same way as in the case of the second relay apparatus 203, converts the message before conversion and generates a converted message. In the conversion processing (A) of this embodiment, removal of duplication and data compression are performed.

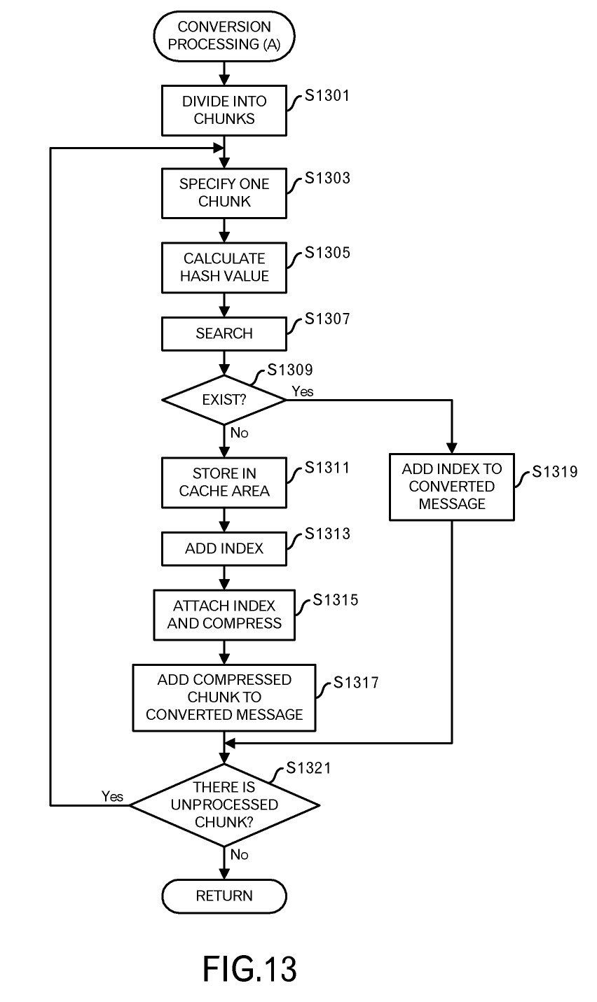

FIG. 13 illustrates a processing flow of the conversion processing (A). The emulation unit 511 divides the message before conversion into chunks (S1301). Conventional techniques are used for dividing the message into chunks.

The emulation unit 511 specifies one chunk from among the divided chunks (S1303). The emulation unit 511 specifies chunks in order from the head, for example.

The emulation unit 511 calculates a hash value for the specified chunk (S1305). The emulation unit 511 may also calculate a hash value using a conventional hash function. The hash value that is calculated at this time is an ID for identifying the original chunk, and is used as an index for reading a chunk that is stored in the cache area. Therefore, the hash value that is calculated at this time is called an index in the following. The emulation unit 511 searches a hash table using the index as a key (S1307).

When the chunk that is the target of processing is already stored in the cache area, that index is in the hash table. On the other hand, when the chunk that is the target of processing is not stored in the cache area, that index is not in the hash table.

The emulation unit 511 determines whether or not that index is in the hash table (S1309). When it is determined that the index is not in the hash table, the emulation unit 511 stores the chunk that is the target of processing in the cache area (S1311). At that time, the emulation unit 511 adds that index to the hash table (S1313).

The emulation unit 511 attaches the index to that chunk as a header, and compresses the entire chunk to which the header is attached (S1315). Then, the emulation unit 511 adds the compressed chunk to the converted message (S1317). The processing then shifts to S1321.

On the other hand, when it is determined that the index is in the hash table, the emulation unit 511 adds that index to the converted message (S1319). The processing then moves to S1321.

The emulation unit 511 determines whether or not there is an unprocessed chunk (S1321). When it is determined that there is an unprocessed chunk, the processing returns to S1303, and the processing described above is repeated.

However, when it is determined that there are no unprocessed chunks, the conversion processing (A) ends, and the processing returns to the first subroutine processing (A) of the calling source.

The explanation returns to the explanation of FIG. 12. After the conversion processing (A) ends, the second measurement unit 509 ends measurement of time and specifies the time required for the conversion processing (A) (hereafter, called the conversion time) (S1215). The second measurement unit 509 then sets the specified conversion time in the conversion record that was made in S1207.

The specification unit 507 specifies a size of the converted message (S1217). The specification unit 507 then similarly sets the specified size in the conversion record.

The controller 503 determines whether or not the controller 503 ends the first subroutine processing (A) (S1219). When processing has advanced to a predetermined ending period, the controller 503 ends the first subroutine processing (A). Alternatively, the controller 503 may end the first subroutine processing (A) when the number of conversion records has reached a predetermined number. When it is determined not to end the first subroutine processing (A), the processing returns to the processing illustrated as S1201, and the processing described above is repeated. After the first subroutine processing (A) ends, the processing returns to the main processing of the calling source.

The explanation returns to the explanation of FIG. 9. The controller 503 gives an instruction to the first measurement unit 501 to end the measurement processing (S905). As described above, the measurement processing ends according to this instruction. The controller 503 then executes a second subroutine processing (S907). In the second subroutine processing, an assessment record is generated. In this embodiment, the controller 503 executes a second subroutine processing (A).

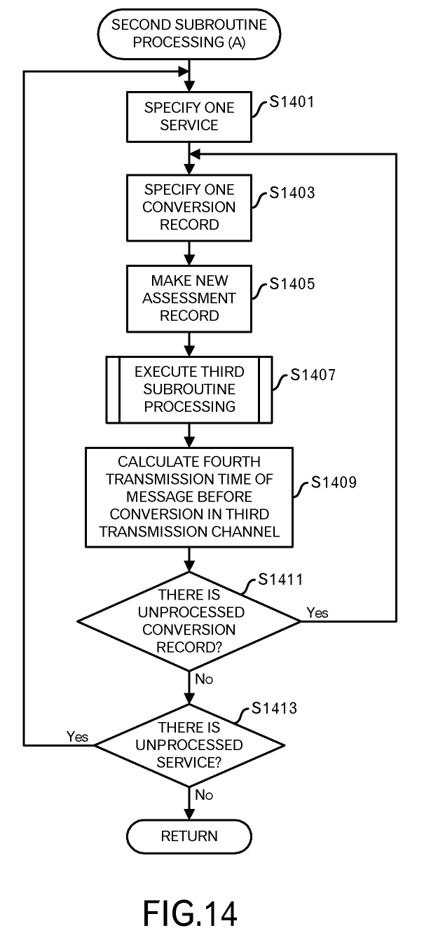

FIG. 14 illustrates the flow of the second subroutine processing (A). The controller 503 specifies one service based on the service table (S1401).

The controller 503 specifies one conversion record in the conversion log that corresponds to the specified service (S1403). Furthermore, the controller 503 makes a new assessment record in the assessment table that corresponds to the specified service (S1405).

The controller 503 executes a third subroutine processing (S1407). In the third subroutine processing, the time required for the applied case is calculated.

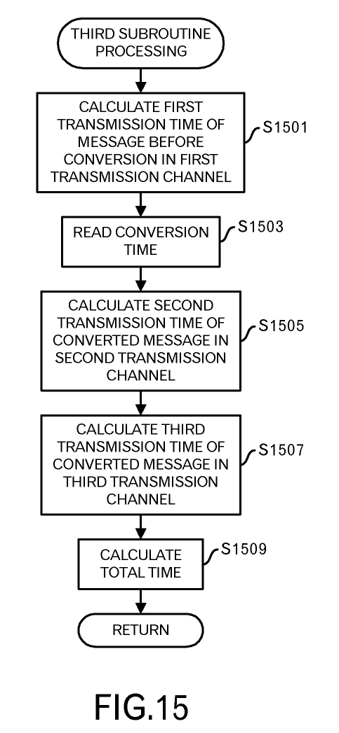

FIG. 15 illustrates the flow of the third subroutine processing. The first calculator 513 calculates the first transmission time (S1501). More specifically, the first calculator 513 calculates the first transmission time by dividing the size of the message before conversion by the first transmission rate. The first calculator 513 then sets the first transmission time in the new assessment record that was made in S1405.

The summation unit 519 reads the conversion time from the conversion record that was specified in S1403 (S1503). Then, the summation unit 519 similarly sets the conversion time in the new assessment record.

The second calculator 515 calculates the second transmission time (S1505). More specifically, the second calculator 515 calculates the second transmission time by dividing the size of the converted message by the second transmission rate. Then, the second calculator 515 similarly sets the second transmission time in the new assessment record.

The third calculator 517 calculates the third transmission time (S1507). More specifically, the third calculator 517 calculates the third transmission time by dividing the size of the converted message by the third transmission rate. Then, the third calculator 517 similarly sets the third transmission time in the new assessment record.

The summation unit 519 calculates the total time of the first transmission time, the conversion time, the second transmission time and the third transmission time (S1509). Then, the summation unit 519 similarly sets the total time in the new assessment record. After the third subroutine processing ends, the processing returns to the second subroutine processing (A) of the calling source.

The explanation returns to the explanation of FIG. 14. The fourth calculator 521 calculates the fourth transmission time (S1409). The fourth calculator 521 calculates the fourth transmission time by dividing the size of the message before conversion by the fourth transmission rate. The fourth calculator 521 then sets the fourth transmission time in the assessment record that was made in S1405.

The controller 503 determines whether or not there are unprocessed conversion records (S1411). When it is determined that there is an unprocessed conversion record, the processing returns to the processing illustrated by S1403, and the processing described above is repeated.

When it is determined that there are no unprocessed conversion records, the controller 503 determines whether or not there are any unprocessed services (S1413). When it is determined that there is an unprocessed service, the processing returns to the processing illustrated by S1401, and the processing described above is repeated.

On the other hand, when it is determined that there are no unprocessed services, the second subroutine processing (A) ends, and the processing returns to the main processing of the calling source.

The explanation returns to the explanation of the main processing (FIG. 9). The determination unit 523 executes a determination processing (S909). In this embodiment, the determination unit 523 executes a determination processing (A). In the determination processing (A), the determination unit 523 determines whether the effect of applying communication data conversion is large or small for each service.

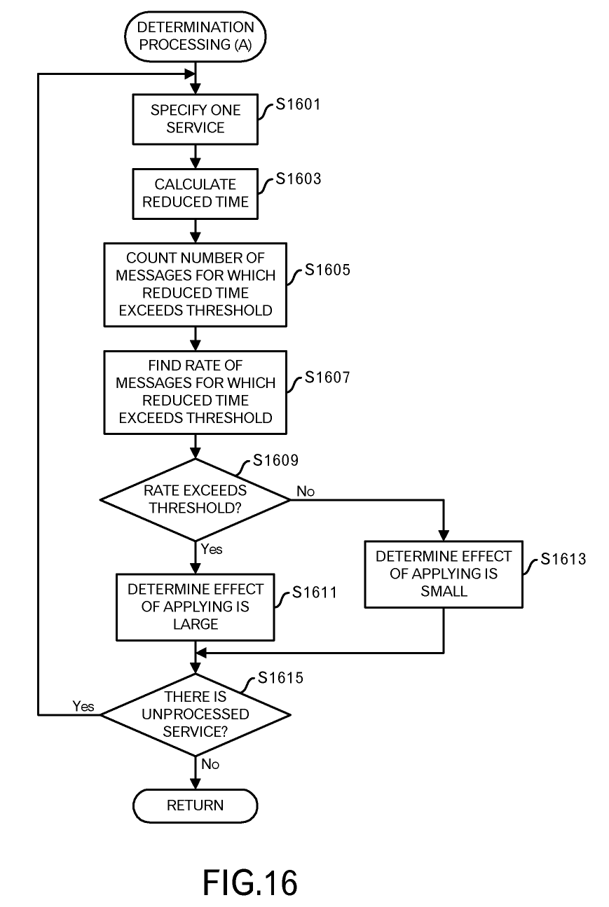

FIG. 16 illustrates a processing flow of the determination processing (A). The determination unit 523 specifies one service based on the service table (S1601).

The determination unit 523 calculates the reduced time for each assessment record that is in the assessment table corresponds to the specified service (S1603). More specifically, the determination unit 523 calculates, for each of the assessment records, a reduced time by subtracting the fourth transmission time from the total time that is set in the assessment records. The determination unit 523 then sets the calculated reduced time in the assessment records.

The determination unit 523 counts the number of messages for which the reduced time exceeds a threshold value (S1605). In other words, the determination unit 523 calculates the number of assessment records for which the reduced time exceeds the threshold value.

The determination unit 523 calculates a rate of messages for which the reduced time exceeds the threshold value (S1607). More specifically, the determination unit 523 calculates that rate by dividing the number of assessment records calculated in S1605 by the total number of assessment records in that assessment table.

The determination unit 523 determines whether or not that rate exceeds the threshold value (S1609). When that rate exceeds the threshold value, the determination unit 523 determines that the effect of applying communication data conversion is large (S1611). On the other hand, when the rate does not exceed the threshold value, the determination unit 523 determines that the effect of applying communication data conversion is small (S1613).

When determination for that service ends, the determination unit 523 determines whether or not there are any unprocessed services (S1615). When it is determined that there is an unprocessed service, the processing returns to the processing illustrated by S1601, and the processing described above is repeated.

On the other hand, when it is determined that there are no unprocessed services, the determination processing (A) ends, and the processing returns to the main processing of the calling source.

The explanation will return to the explanation of the main processing (FIG. 9). The output unit 525 outputs the determination result (S911). More specifically, the output unit 525 output a determination result for each service. The output is performed by, for example, displaying, transmitting, or recording the determination result.

With this embodiment, in the system being operated, it is possible for the second relay apparatus 203 to verify the effect when communication data conversion is applied. Therefore, there is an aspect of conserving labor for switching the transmission path. Moreover, there is an aspect of completing processing without disturbing operation of the system.

Moreover, in regard to a message that is sent from a particular service, it is possible for the second relay apparatus 203 to verify the effect of the case where communication data conversion is applied.

### Embodiment 2

In the embodiment described above, an example of verifying the effect of applying communication data conversion to each service was explained. However, in this embodiment, an example of verifying the effect of applying communication data conversion to each session will be explained.

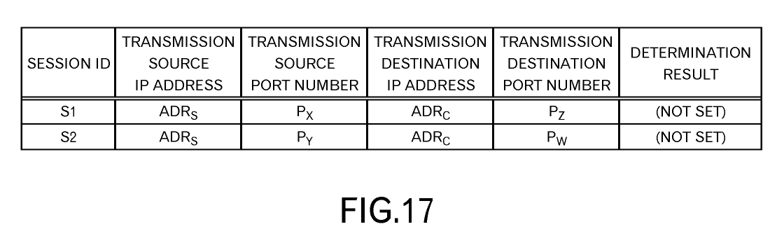

In this embodiment, a session table is used instead of a service table. Session tables are scored in the table storage unit 541. FIG. 17 illustrates an example of a configuration of a session table. The session table in this example has records that correspond to sessions (hereafter, called session records).

A session record has a field for setting a session ID, a field for setting an IP address of the transmission source, a field for setting a port number of the transmission source, a field for setting an IP address of the destination, a field for setting a port number of the destination, and a field for setting a determination result.

The session ID identifies a session that is the target of verification. The IP address of the transmission source is an IP address of an apparatus that provides a service in the session that is the target of verification. The port number of the transmission source is a port number that is used for the service in the session that is the target of verification. The IP address of the destination is an IP address of the apparatus that uses the service in the session that is the target of verification. The port number of the destination is a port number of a program that uses the service in the session that is the target of verification. The determination result represents whether an effect of applying communication data conversion to the session that is the target of verification is large or small.

The first session record illustrated in FIG. 17 represents that session “S1”, in the case where a program that operates on the apparatus having the IP address “ADR_{C}” for which the port number “P_{Z}” is assigned uses a service that is provided by an apparatus having the IP address “ADR_{S}” by port number “P_{X}”, is the target of verification. In this example, a determination result has not been set yet.

Similarly, the second session record represents that session “S2”, in the case where a program that operates on the apparatus having the IP address “ADR_{C}” for which the port number “P_{W}” is assigned uses a service that is provided by an apparatus having the IP address “ADR_{S}” by port number “P_{Y}”, is the target of verification. In this example, a determination result has not set yet.

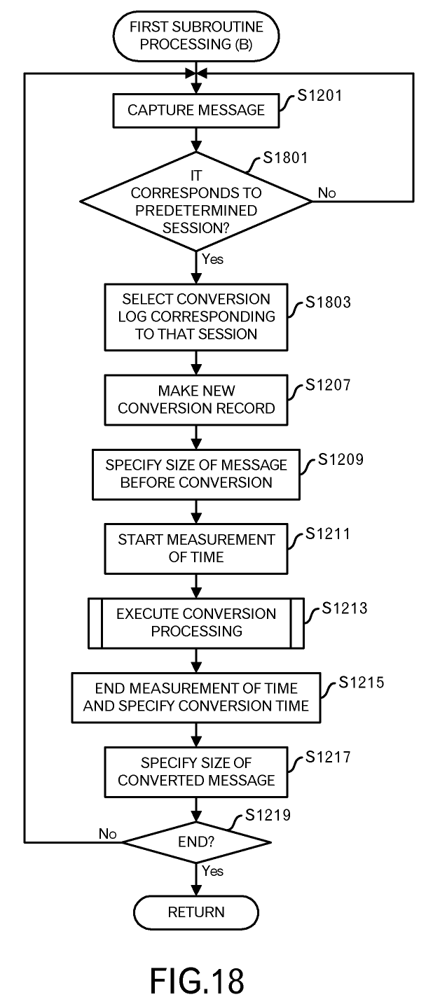

In this embodiment, a first subroutine (B) is executed instead of the first subroutine (A) illustrated in FIG. 12. FIG. 18 illustrates a processing flow of the first subroutine processing (B). The processing illustrated in S1201 is the same as in the case in FIG. 12.

The controller 503 determines whether or not the session for a captured message corresponds to a predetermined session (S1801). More specifically, when the IP address of the transmission source, the port number of the transmission source, the IP address of the destination and the port number of the destination that are set in the captured message all match a combination of an IP address of the transmission source, a port number of the transmission source, an IP address of the destination and a port number of the destination that is set in any of the session records, the controller 503 determines that the session for that message corresponds to the predetermined session.

When it is determined that the session for the captured message does not correspond to the predetermined session, the processing returns to the processing illustrated by S1201, and the processing described above is repeated.

On the other hand, when it is determined that the session for the captured message corresponds to the predetermined session, the controller 503 selects a conversion log that corresponds to that session (S1803).

The processing illustrated by S1207 to S1219 is the same as in the case in FIG. 12.

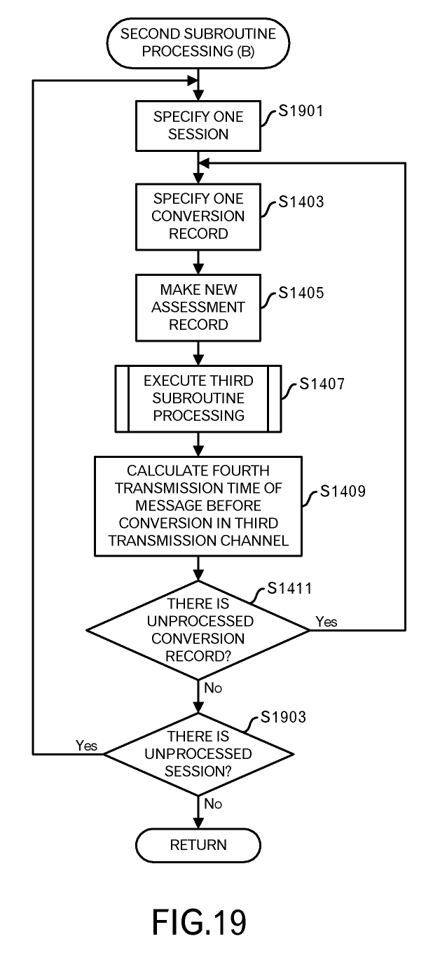

Moreover, in this embodiment, the second subroutine processing (B) is executed instead of the second subroutine processing (A) illustrated in FIG. 14. FIG. 19 illustrates a processing flow of the second subroutine processing (B).

The controller 503 specifies one session based on the session table (S1901). In the processing below, that session is taken to be the target of processing. More specifically, the controller 503 specifies one conversion record in the conversion log that corresponds to the specified session (S1403). The controller 503 also makes a new assessment record in the assessment table that corresponds to the specified session (S1405).

The processing illustrated in S1407 to S1411 is the same as in the case illustrated in FIG. 14.

The controller 503 determines whether or not there are any unprocessed sessions (S1903). When it is determined that there is an unprocessed session, the processing returns to the processing illustrated in S1901, and the processing described above is repeated.

On the other hand, when it is determined that there are no unprocessed sessions, the second subroutine processing (B) ends, and the processing returns to the main processing of the calling source.

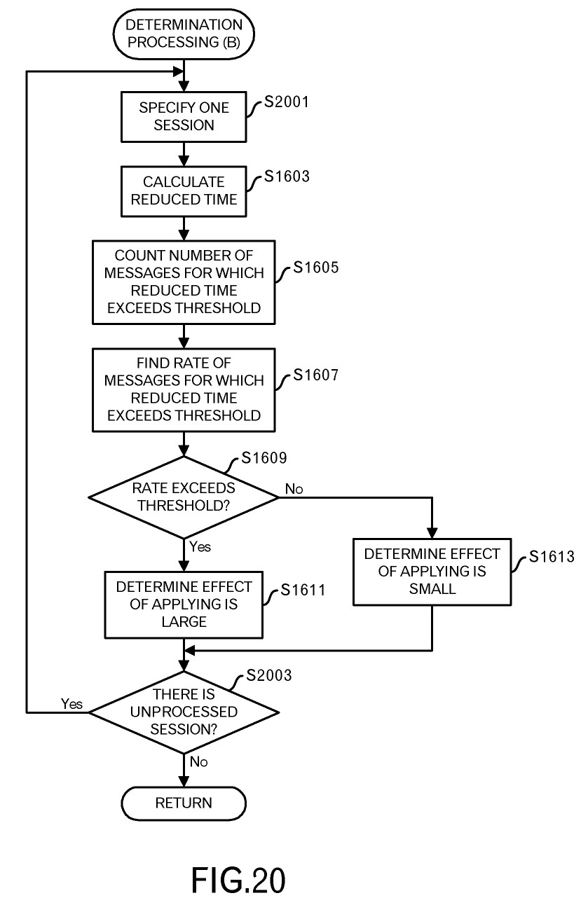

Furthermore, in this embodiment, a determination processing (B) is executed instead of the determination processing (A) illustrated in FIG. 16. FIG. 20 illustrates a processing flow of the determination processing (B).

The determination unit 523 specifies one session based on the session table (S2001). In the processing below, that session is taken to be the target of processing. More specifically, the determination unit 523 specifies each assessment record of the assessment table that corresponds to the specified session. The processing of S1603 to S1613 is the same as in the case illustrated in FIG. 16.

The determination unit 523 determines whether or not there are any unprocessed sessions (S2003). When it is determined that there is an unprocessed session, the processing returns to the processing illustrated in S2001, and the processing described above is repeated.

On the other hand, when it is determined that there are no unprocessed sessions, the determination processing (B) ends, and the processing returns to the main processing of the calling source.

With this embodiment, it is possible to verify the effect of the case of applying communication data conversion by the second relay apparatus 203 for a message that is sent in a specific session.

### Embodiment 3

In the embodiments described above, examples of verifying the effect of applying communication data conversion based on the reduced time were explained. However, the effect of applying communication data conversion may be further verified based on the reduction rate of data. In this embodiment, the average reduction rate of the size of each message is taken as a reference.

FIG. 21 illustrates an example of a configuration of a conversion log of a third embodiment. Conversion records in the third embodiment have, in addition to the fields described above, a field for setting the reduction rate. The reduction rate is a rate that the size of a message is reduced due to communication data conversion.

The first conversion record illustrated in FIG. 21 represents that a message specified by the message ID “M1” is reduced by the rate “D₁” due to communication data conversion. Similarly, the second conversion record represents that a message specified by the message ID “M2” is reduced by the rate “D₂” due to communication data conversion. Similarly, the third conversion record represents that a message specified by the message ID “M3” is reduced by the rate “D₃” due to communication data conversion.

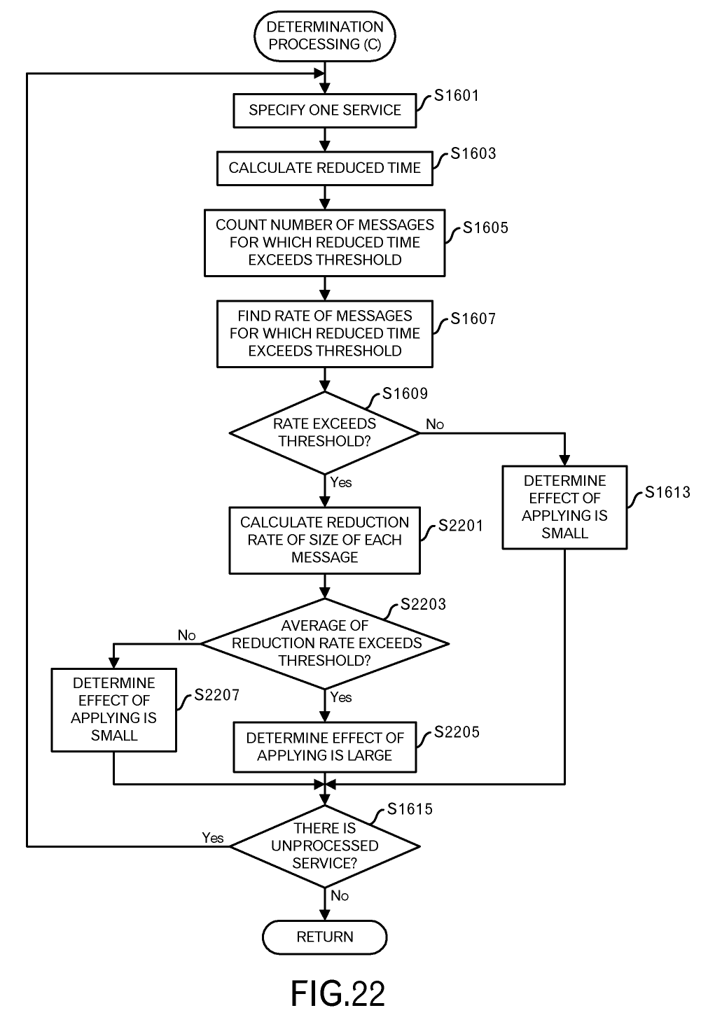

In this embodiment, determination processing (C) is executed instead of the determination processing (A) illustrated in FIG. 16. FIG. 22 illustrates a processing flow of the determination processing (C). The processing illustrated in the S1601 to S1609 is the same as in the case illustrated in FIG. 16.

In S1609, when it is determined that the rate calculated in S1607 exceeds a threshold value, the determination unit 523 calculates a reduction rate of the size of each message (S2201). More specifically, the determination unit 523 calculates a reduction amount by subtracting the size of the converted message from the size of the message before conversion for each conversion record. The determination unit 523 then calculates the reduction rate by dividing the reduced amount by the size of the message before conversion.

The determination unit 523 calculates an average reduction rate of the size of each message, and determines whether or not that average reduction rate is greater than a threshold value (S2203).

When that average reduction rate is greater than a threshold value, the determination unit 523 determines that the effect of applying communication data conversion is large (S2205). On the other hand, when that average reduction rate is not greater than a threshold value, the determination unit 523 determines that the effect of applying communication data conversion is small (S2207).

The processing illustrated in S1613 and S1615 is the same as in the case illustrated in FIG. 16.

With this embodiment, when the reduced time exceeds a threshold value and the average reduction rate of data also exceeds a threshold value, applying communication data conversion is determined to be effective. And thus it is possible to verify that both a condition for a speed of data transmission and a condition for reduction in a data amount are satisfied.

### Embodiment 4

In the third embodiment, an example of taking the average reduction rate of the size of each message as a reference was explained. However, in this fourth embodiment, an example of taking the reduction rate of the total size of messages will be explained.

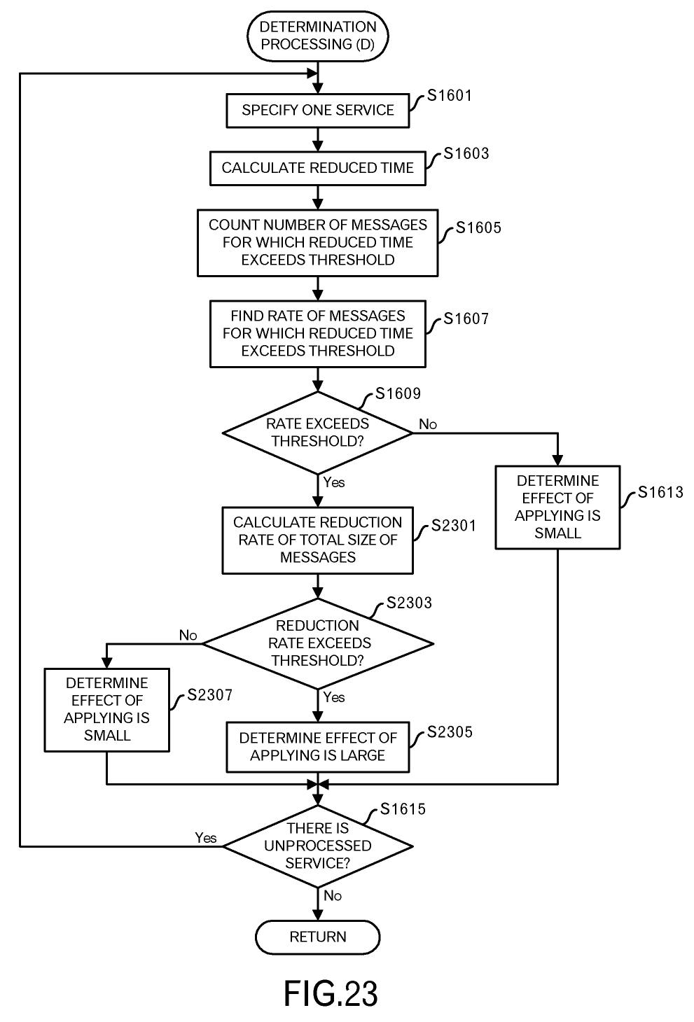

In this embodiment, determination processing (D) is executed instead of the determination processing (A) illustrated in FIG. 16. FIG. 23 illustrates a processing flow of the determination processing (D). The processing of S1601 to S1609 is the same as in the case illustrated in FIG. 16.

In S1609, when it is determined that the rate calculated in S1607 exceeds the threshold value, the determination unit 523 calculates a reduction rate of the total size of messages (S2301). More specifically, the determination unit 523 calculates a total of sizes of the messages before conversion, which are set in the conversion records, and similarly calculates a total of sizes of the converted messages. Furthermore, the determination unit 523 calculates an overall amount of reduction by subtracting the total size of converted messages from the total size of messages before conversion. The determination unit 523 then calculates a reduction rate of the total size of messages by dividing the overall reduction amount by the total size of messages before conversion.

The determination unit 523 determines whether or not the reduction rate of the total size of messages is greater than a threshold value (S2303). When the reduction rate of the total size of messages is greater than the threshold value, the determination unit 523 determines that the effect of applying communication data conversion is large (S2305).

On the other hand, when the reduction rate of the total size of messages is not greater than a threshold value, the determination unit 523 determines that the effect of applying communication data conversion is small (S2307).

The processing illustrated in S1613 to S1615 is the same as in the case illustrated in FIG. 16.

With this embodiment, when the reduced time exceeds a threshold value and also the reduction rate of the total size of messages is greater than a threshold value, it is determined that applying communication data conversion is effective. And thus it is possible to verify that both a condition for a speed of data transmission and a condition for reduction in a data amount are satisfied.

### Embodiment 5

In the third embodiment, an example of verifying the effect of applying communication data conversion based on the reduction rate of data for each service was explained. However, in this fifth embodiment, an example of verifying the effect of applying communication data conversion based on the reduction rate for each session is explained. In this embodiment, as in the third embodiment, the average reduction rate of the size of each message is taken to be a reference.

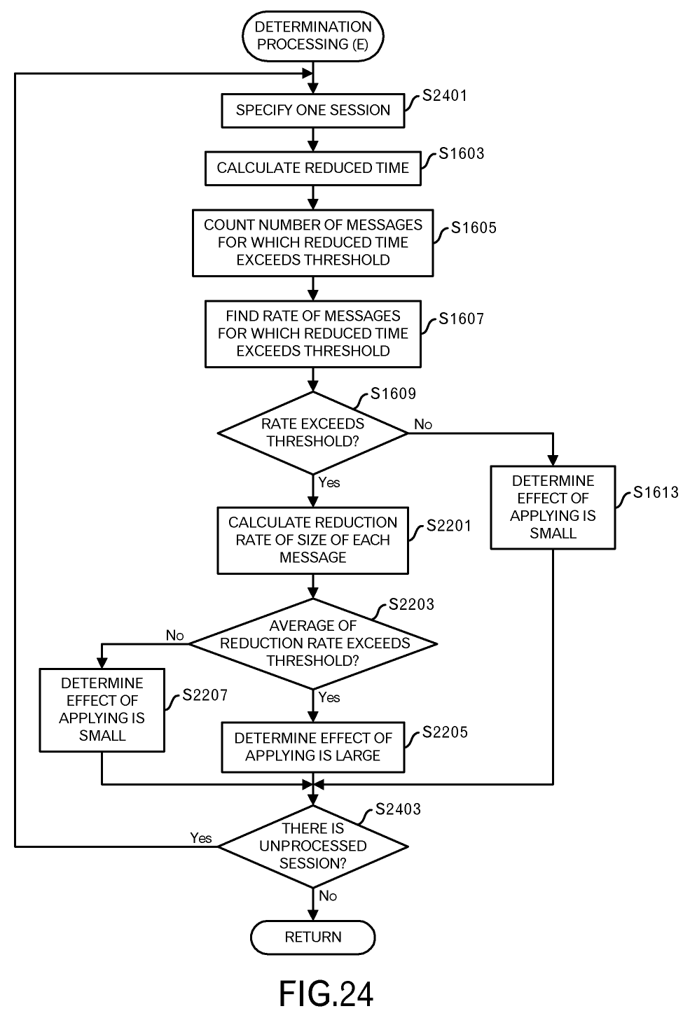

In this embodiment, determination processing (E) is executed instead oil the determination processing (C) illustrated in FIG. 22. FIG. 24 illustrates a processing flow of the determination processing (E). The determination unit 523 specifies one session based on a session table (S2401). Hereafter, that session is taken to be the target of processing. More specifically, the determination unit 523 specifies each assessment record in the assessment table that corresponds to the specified session. The processing illustrated in S1603 to S1609, the processing illustrated in S2201 to S2207, and the processing illustrated in S1613 are the same as in the case illustrated in FIG. 22.

The determination unit 523 determines whether or not there are any unprocessed sessions (S2403). When it is determined that there is an unprocessed session, the processing returns to the processing illustrated in S2401, and the processing described above is repeated.

On the other hand, when it is determined that there are no unprocessed sessions, the determination processing (E) ends, and the processing returns to the main processing of the calling source.

With this embodiment, it is possible to verify that both a condition for a speed of data transmission and a condition for reduction in a data amount are satisfied for each session.

### Embodiment 6

It is also possible to verify the effect of applying communication data conversion by using the reduction rate of the total size of messages as a reference for each session. In other words, in this embodiment, the target of processing is changed from a service to a session in the fourth embodiment.

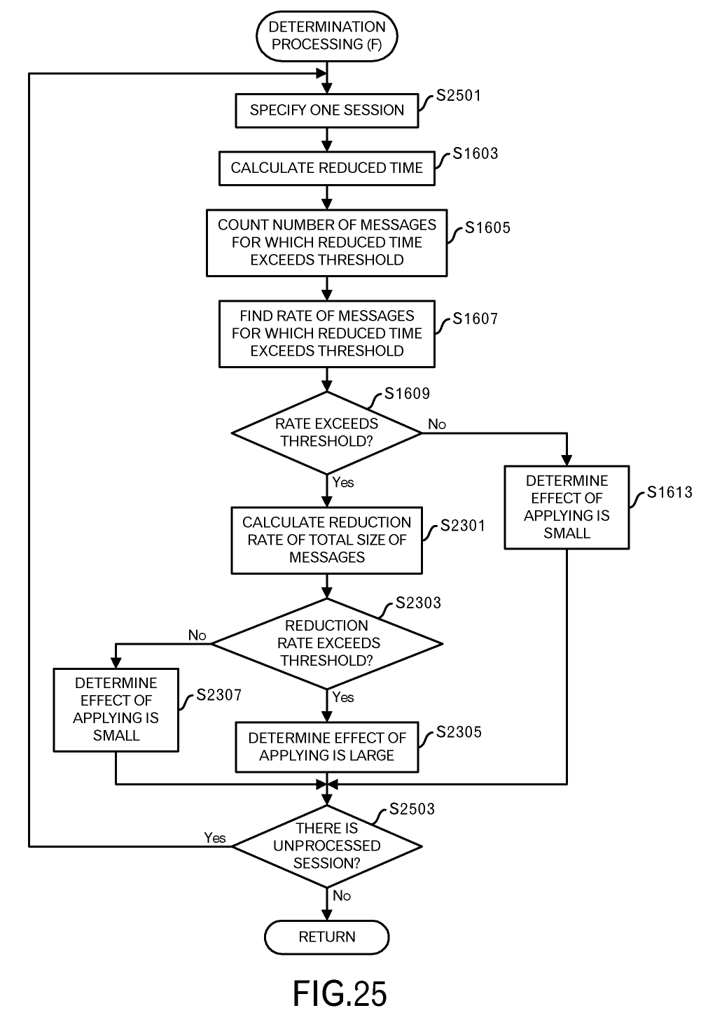

In this embodiment, determination processing (F) is executed instead of the determination processing (D) illustrated in FIG. 23. FIG. 25 illustrates a processing flow of the determination processing (F). The determination unit 523 specifies one session based on a session table (S2501). In the processing below, that session is taken to be the target of processing. More specifically, the determination unit 523 specifies each assessment record in the assessment table that corresponds to the specified session. The processing illustrated in S1603 to S1609, the processing illustrated in S2301 to S2307, and the processing illustrated in S1613 are the same as in the case illustrated in FIG. 23.

The determination unit 523 determines whether or not there are any unprocessed sessions (S2503). When it is determined that there is an unprocessed session, the processing returns to the processing illustrated in S2501, and the processing described above is repeated.

On the other hand, when it is determined that there are no unprocessed sessions, the determination processing (F) ends, and the processing returns to the main processing of the calling source.

With this embodiment, it is possible to verify that both a condition for a speed of data transmission and a condition for reduction in data amount are satisfied for each session by using the reduction rate of the total size of messages as a reference.

### Embodiment 7

In the third to sixth embodiments, examples of determining the effect of applying communication data conversion when a condition for reduced time is satisfied, and when a condition for the reduction rate of data is satisfied were explained. However, it is also possible to determine that applying communication data conversion is effective even when only one of the conditions is satisfied. In seventh to tenth embodiments, examples of determining that applying communication data conversion is effective when the condition for the reduction rate of data is satisfied even when the condition for reduced time is not satisfied are explained.

In a seventh embodiment, with a service taken to be the target of verification, condition determination related to the average reduction rate of the size of each message is performed when the condition for reduced time is not satisfied.

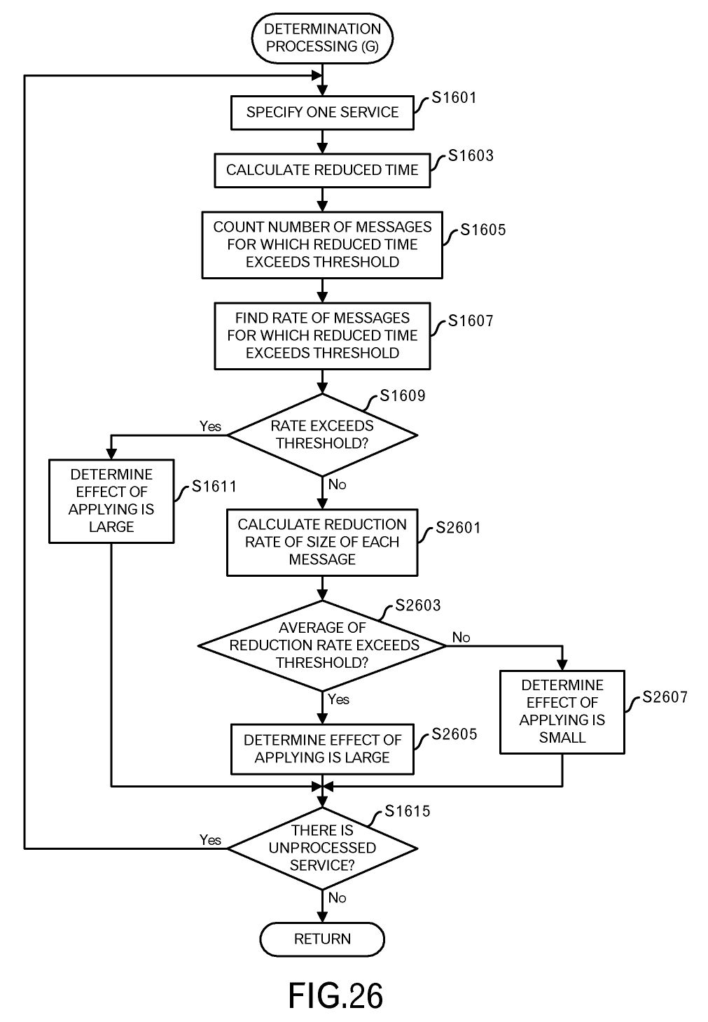

In this embodiment, determination processing (G) is executed instead of the determination processing (A) illustrated in FIG. 16. FIG. 26 illustrates a processing flow of the determination processing (G). The processing illustrated in S1601 to S1611 is the same as in the case illustrated in FIG. 16.

In S1609, when it is determined that the rate calculated in S1607 does not exceed a threshold value, the determination unit 523 calculates the reduction rate of the size of each message (S2601). The determination unit 523 then determines whether or not the average of the reduction rates is greater than a threshold value (S2603).

When it is determined that the average reduction rate is greater than the threshold value, the determination unit 523 determines that the effect of applying communication data conversion is large (S2605). However, when it is determined that the average reduction rate is not greater than the threshold value, the determination unit 523 determines that the effect of applying communication data conversion is small (S2607).

The processing illustrated in S1615 is the same as in the case illustrated in FIG. 16.

With this embodiment, it is possible to verify that a condition for a speed of data transmission, or a condition related to the average reduction rate of size of each message is satisfied for each service.

### Embodiment 8

In this embodiment, with a service taken to be the target of verification, an example of determining that applying communication data conversion is effective when a condition related to the reduction rate of the total size of messages is satisfied even though the condition for reduced time is not satisfied will be explained.

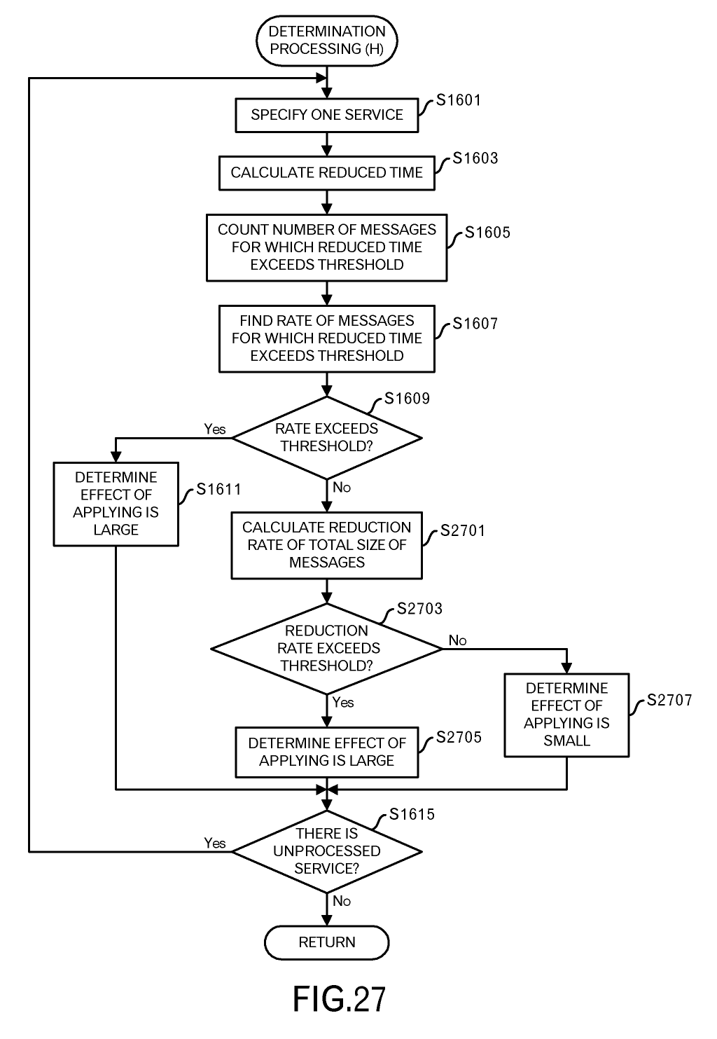

In this embodiment, determination processing (H) is executed instead of the determination processing (A) illustrated in FIG. 16. FIG. 27 illustrates a processing flow of the determination processing (H). The processing illustrated in S1601 to S1611 is the same as in the case illustrated in FIG. 16.

In S1609, when it is determined that the rate calculated in S1607 does not exceed a threshold value, the determination unit 523 calculates the reduction rate of the total size of messages (S2701). The determination unit 523 then determines whether or not that reduction rate is greater than a threshold value (S2703).

When it is determined that the reduction rate is greater than a threshold value, the determination unit 523 determines that the effect of applying communication data conversion is large (S2705). However, when it is determined that the reduction rate is not greater than a threshold value, the determination unit 523 determines that the effect of applying communication data conversion is small (S2707).

The processing illustrated in S1615 is the same as in the case illustrated in FIG. 16.

With this embodiment, it is possible to verify that a condition for a speed of data transmission, or a condition related to the reduction rate of the total size of messages is satisfied for each service.

### Embodiment 9

In this embodiment, with a session as the target, an example of determining that applying communication data conversion is effective when a condition related to the average reduction rate of the size of each message is satisfied even when the condition of reduced time is not satisfied is explained.

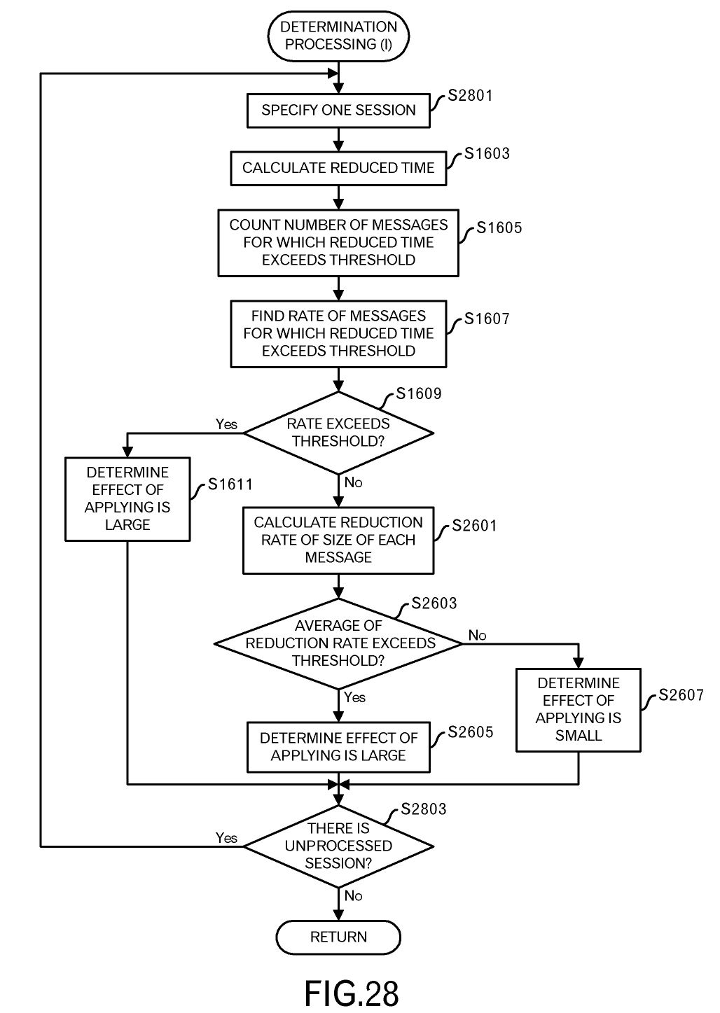

In this embodiment, determination processing (I) is executed instead of the determination processing (G) that is illustrated in FIG. 26. FIG. 28 illustrates a processing flow of the determination processing (I). The determination unit 523 specifies one session based on a session table (S2801). In the processing below, that session is taken to be the target of processing. The processing illustrated in S1603 to S1611, and the processing illustrated in S2601 to S2607 are the same as in the case illustrated in FIG. 26.

The determination unit 523 determines whether or not there are any unprocessed sessions (S2803). When it is determined that there is an unprocessed session, the processing returns to the processing illustrated in S2801, and the processing described above is repeated.

On the other hand, when it is determined that there are no unprocessed sessions, the determination processing (I) ends, and the processing returns to the main processing of the calling source.

With this embodiment, it is possible to verify that a condition of a speed of data transmission, or a condition related to the average reduction rate of the size of each message is satisfied for each session.

### Embodiment 10

In this embodiment, with a session as the target, an example of determining that applying communication data conversion is effective when a condition related to the reduction rate of the total size of messages is satisfied even when the condition of reduced time is not satisfied is explained.

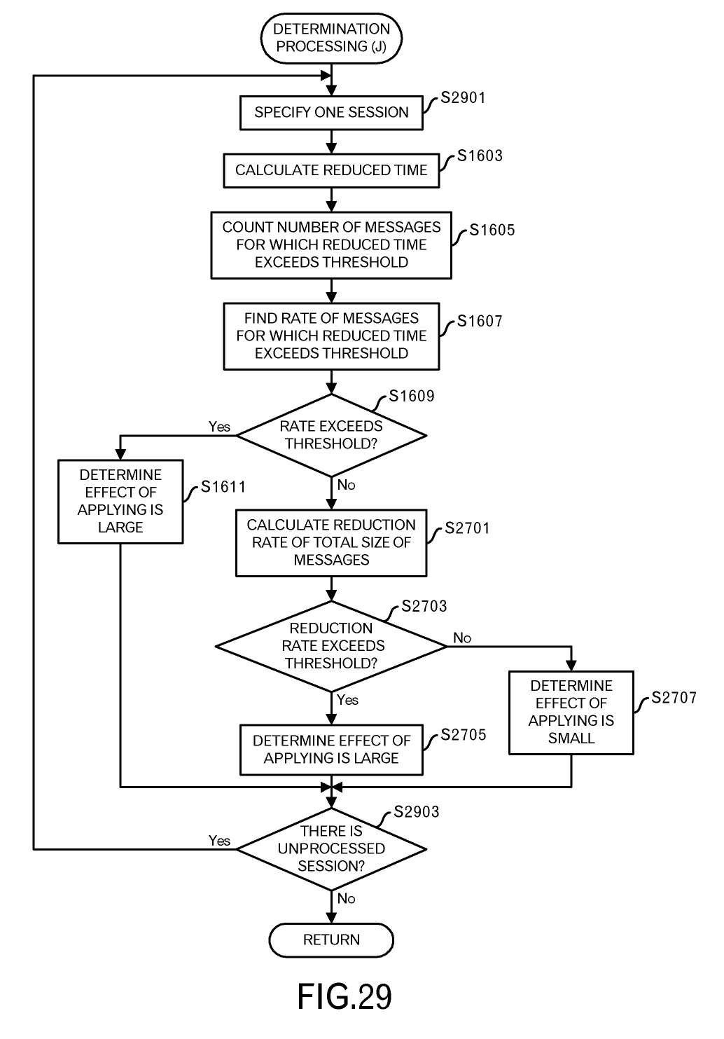

In this embodiment, determination processing (J) is executed instead of the determination processing (H) that is illustrated in FIG. 27. FIG. 29 illustrates a processing flow of the determination processing (J). The determination unit 523 specifies one session based on a session table (S2901). In the processing below, that session is taken to be the target of processing. The processing illustrated in S1603 to S1611, and the processing illustrated in S2701 to S2707 are the same as in the case in FIG. 27.

The determination unit 523 determines whether or not there are any unprocessed sessions (S2903). When it is determined that there is an unprocessed session, the processing returns to the processing illustrated in S2901, and the processing described above is repeated.

On the other hand, when it is determined that there are not any unprocessed sessions, the determination processing (J) ends, and the processing returns to the main processing of the calling source.

With this embodiment, it is possible to verify that a condition for a speed of data transmission, or a condition related to the reduction rate of the total size of messages is satisfied for each session.

### Embodiment 11

In this embodiment, a case in which partial association is not performed for an element of required time in the applied case is assumed.

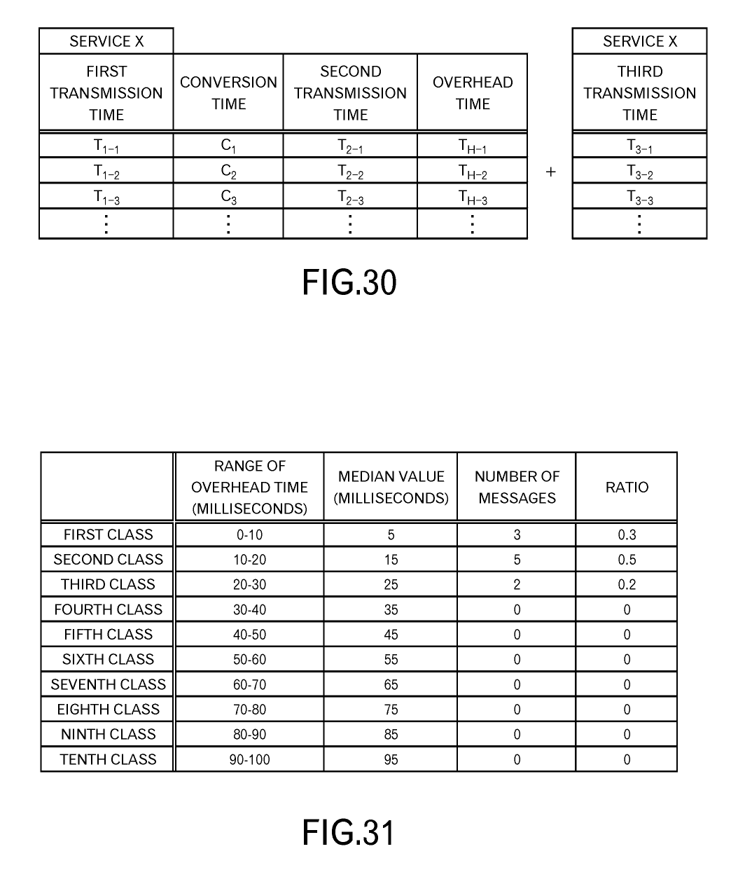

FIG. 30 illustrates an example of configuration of an assessment table in this eleventh embodiment. Of the data included in this assessment table, data that is related to the required time in the applied ease is assumed to be divided into two tables.

In the table on the left side, a time that corresponds to the overhead of communication data conversion is set. More specifically, records in the table on the left side have a field for setting the first transmission time, a field for setting the conversion time, a field for setting the second transmission time, and a field for setting the overhead time. As was described above, the overhead time is the total of the first transmission time, the conversion time and the second transmission time.

In the table on the right side, the transmission time in the WAN is set. In other words, the records in the table on the right side have a field for setting the third transmission time.

The records in the table on the left side and the records in the table on the right side are not associated. In other words, the overhead time and the transmission time in the WAN are not associated. In this embodiment, if is assumed that there is no association between the overhead time and the transmission time in the WAN, and distribution of the required time in the applied case is calculated.

First, the frequency distribution of the overhead time that is generated based on the table that is illustrated on the left side in FIG. 30 will be explained.

FIG. 31 illustrates an example of a first frequency distribution table. The first frequency distribution table corresponds to the frequency distribution of the overhead time. The first frequency distribution table in this example has records that correspond to classes. The records in the first frequency distribution table have a field for setting the range of the overhead time, a field for setting a median value, a field for setting the number of messages, and a field for setting a ratio.

The unit for the overhead time is milliseconds (ms). Values are set beforehand for the range of the overhead time and the median value. In this example, for the convenience of explanation, a field for a median value is provided, however, it is also possible to omit the field for a median value.

The number of messages is the number of messages in a range of the overhead time, and corresponds to the frequency. The ratio is a rate that the number of messages occupies with respect to the total.

The first record illustrated in FIG. 31 represents that the number of messages in the first class, for which the overhead time is “not less than 0 ms, but less than 10 ms”, is three. Furthermore, the first record represents that the ratio of the messages in the first class with respect to the total is “0.3”. Similarly, the second record represents that the number of messages in the second class, for which the overhead time is “not less than 10 ms, but less than 20 ms”, is five. Furthermore, the second record represents that the ratio of the messages in the second class with respect to the total is “0.5”. Similarly, the third record represents that the number of messages in the third class, for which the overhead time is “not less than 20 ms, but less than 30 ms”, is two. Furthermore, the third record represents that the ratio of the messages in the third class with respect to the total is “0.2”. Similarly, the fourth record to the tenth record represent that there are no messages that are in the fourth class to the tenth class.

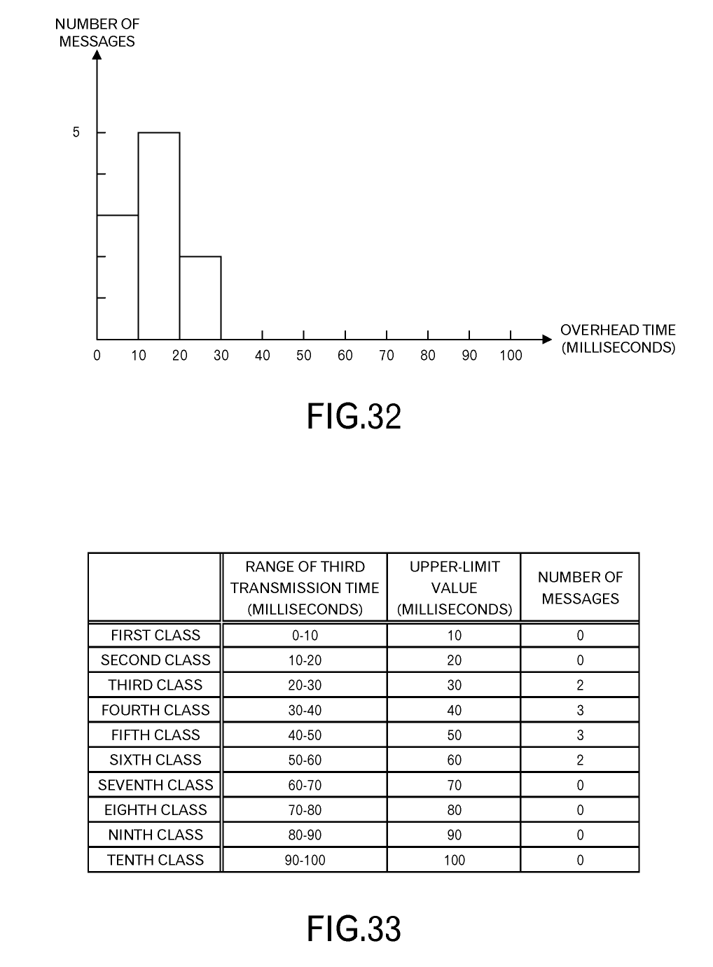

A first histogram that is illustrated in FIG. 32 represents the frequency distribution of the overhead time illustrated in FIG. 31.

Next, the frequency distribution of the third transmission time that is generated based on the table illustrated on the right side in FIG. 30 will be explained.

FIG. 33 illustrates an example of a second frequency distribution table. The second frequency distribution table corresponds to a frequency distribution table for the third transmission time. The second frequency distribution table in this example has records corresponding to classes. The records in the second frequency distribution table have a field for setting the range of the third transmission time, a field for setting the upper-limit value, and a field for setting the number of messages.

The unit of the third transmission time is milliseconds. Values are set beforehand for the range of the third transmission time and the upper limit value. In this example, for convenience of explanation, a field for an upper-limit value is provided, however, it is also possible to omit the field for upper-limit value. The number of messages is the number of messages in the range of the third transmission time, and corresponds to the frequency.

The first record and second record illustrated in FIG. 33 represent that there are no messages in the first class and second class. Similarly, the third record represents that the number of messages in the third class, for which the third transmission time is “not less than 20 ms, but less than 30 ms”, is two. Similarly, the fourth record represents that the number of messages in the fourth class, for which the third transmission time is “not less than 30 10 ms, but less than 40 ms”, is three. Similarly, the fifth record represents that the number of messages in the fifth class, for which the third transmission time is “not less than 40 ms, but less than 50 ms”, is three. Similarly, the sixth record represents that the number of messages in the sixth class, for which the third transmission time is “not less than 50 ms, but less than 60 ms”, is two. Similarly, the seventh record to the tenth record represent that there are no messages in the seventh class to the tenth class.

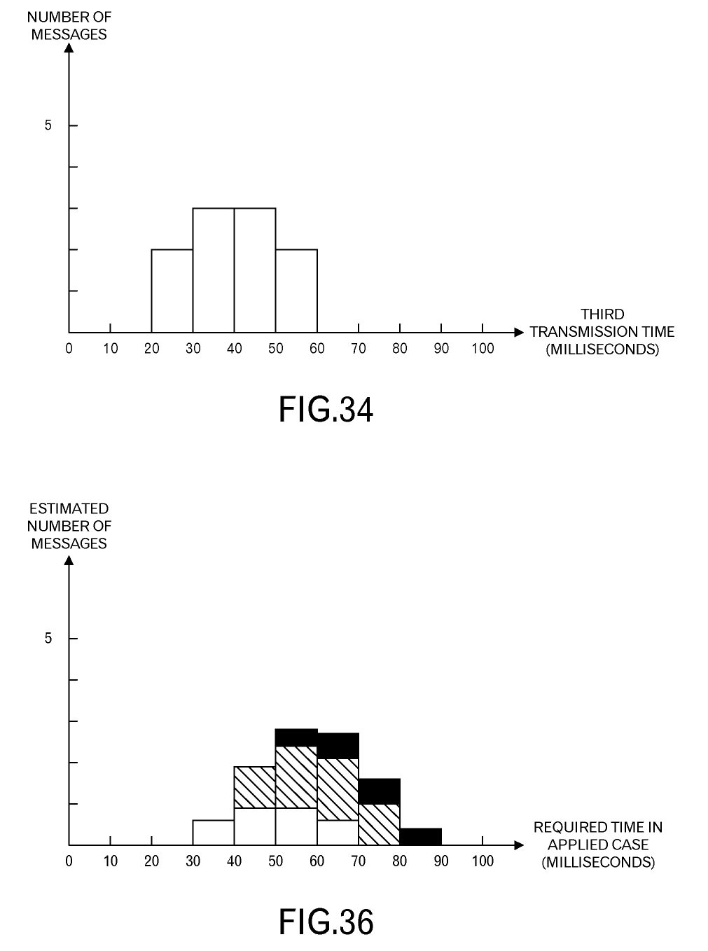

A second histogram that is illustrated in FIG. 34 represents the frequency distribution of the third transmission time illustrated in FIG. 33.

In this embodiment, the frequency distribution for the required time in the applied case is calculated based on the frequency distribution of the overhead time and the frequency distribution of the third transmission time as described above. More specifically, the number of messages in each class in the frequency distribution of the third transmission time is assigned to the respective class of required time in the applied case, based on ratios of classes in the frequency distribution of the overhead time. The class of required time in the applied case is specified based on the sum of the median value in the class of the frequency distribution of the overhead time and the upper-limit value in the class of the frequency distribution of the third transmission time.

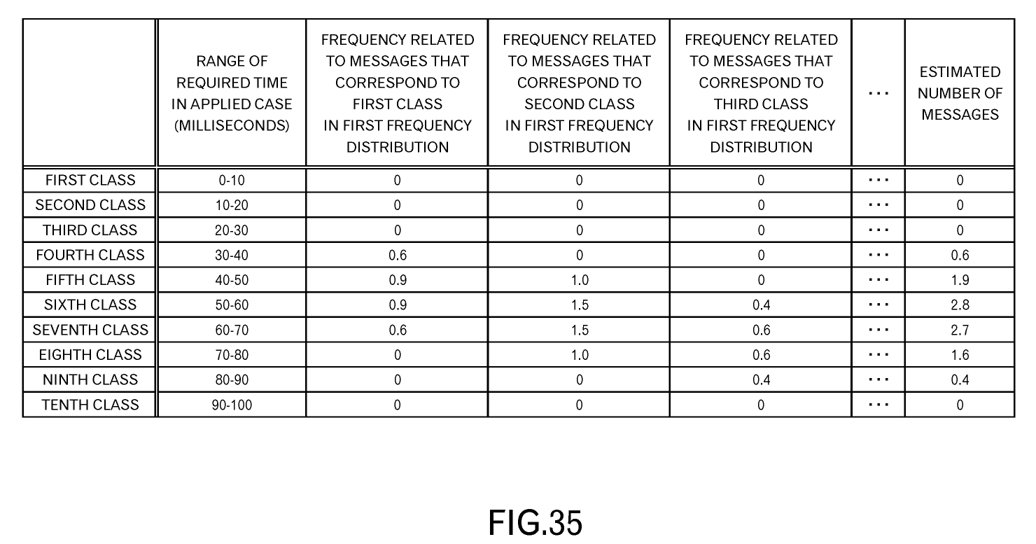

A third frequency distribution table that is illustrated in FIG. 35 is used for calculating the frequency distribution of the required time in the applied case. The third frequency distribution table in this example has records that correspond to classes. The records in the third frequency distribution table have a field for setting the frequency related to messages in each class in the first frequency distribution (hereafter, this is called the frequency based on the Nth (N=1 to 10) class), and a field for setting the estimated number of messages.

For example, the first class of frequency distribution of the overhead time, and the third class of frequency distribution of the third transmission time will be focused on. The fourth class that corresponds to the range “not less than 30, but less than 40” of the required time in the applied case is specified based on the total “35” of the median value “5” in the first class of frequency distribution of the overhead time and the upper-limit value “30” in the third class of frequency distribution of the third transmission time. Then, the product “0.6” of the number of messages “2” in the third class of frequency distribution of the third transmission time and the ratio “0.3” in the first class of frequency distribution of the overhead time is set in the frequency field that is based on the first class in the fourth record of the third frequency distribution table.

The same processing is performed for a combination of each class in the frequency distribution of the overhead time and each class in the frequency distribution of the third transmission time. Then, the totals of the frequencies based on the first class to the frequency based on the tenth class are calculated for each record of the third frequency distribution table, and those totals are set in the fields for the number of estimated messages.

The third histogram illustrated in FIG. 36 represents the frequency distribution in the third frequency distribution table. The pillars represented by grid lines represent the frequency based on the first class. The total frequency based on the first class matches the frequency in the first class illustrated in FIG. 32. Moreover, the distribution of frequency based on the first class has a shape that follows the same ratio as the distribution illustrated in FIG. 34.

The pillars represented by the diagonal lines represent the frequency based on the second class. The total of frequency based on the second class matches the frequency in the second class illustrated in FIG. 32. Moreover, the distribution of frequency based on the second class has a shape that follows the same ratio as the distribution illustrated in FIG. 34.

The filled-in pillars represent the frequency based on the third class. The total frequency based on the third class matches the frequency in the third class illustrated in FIG. 32. Moreover, the distribution of frequency based on the third class has a shape that follows the same ratio as the distribution illustrated in FIG. 34.

The total length of the pillars corresponds to the estimated value for the number of messages in the range of required time in the applied case.

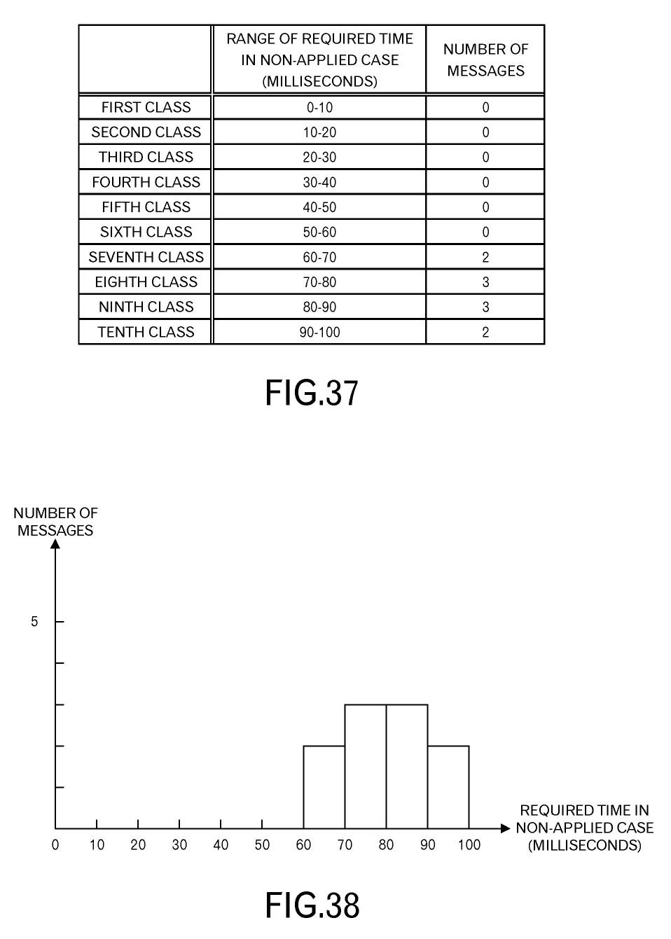

On the other hand, the frequency distribution is also calculated nor the required time in the non-applied case. A fourth frequency distribution table that is illustrated in FIG. 37 corresponds to a frequency distribution table for the required time in the non-applied case. The fourth frequency distribution table in this example has records that correspond to classes. The records in the fourth frequency distribution table have a field for setting the range of the required time in the non-applied case, and a field for setting the number of messages. Values are set beforehand for the ranges of required time in the non-applied case. The number of messages corresponds to the frequency.

The first record to the sixth record illustrated in FIG. 37 represent that there are no messages that correspond to the first class to the sixth class. Similarly, the seventh record corresponds to the seventh class, and represents that the number of messages for which the required time in the non-applied case (in other words, fourth transmission time) is “not less than 60 ms, but less than 70 ms” is two. Similarly, the eighth record corresponds to the eighth class, and represents that the number of messages for which the required time in the non-applied case is “not less than 70 ms, but less than 80 ms” is three. Similarly, the ninth record corresponds to the ninth class, and represents that the number of messages for which the required time in the non-applied case is “not less than 80 ms, but less than 90 ms” is three. Similarly, the tenth record corresponds to the tenth class, and represents that the number of messages for which the required time in the non-applied case is “not less than 90 ms, but less than 100 ms” is two.

A fourth histogram illustrated in FIG. 38 represents the frequency distribution of the required time in the non-applied case, which is illustrated in FIG. 37.

Then, by comparing the frequency distribution of the required time in the applied case with the frequency distribution of the required time in the non-applied case, it is determined whether or not there is a strong tendency to shorten the required time by applying communication data conversion. Conventional techniques may be used as methods for comparing the frequency distributions.

With this embodiment, it is possible to estimate the required time in the applied case even when the overhead time and the third transmission time are not associated.

### Embodiment 12

When the overhead time and the third transmission time are not associated, it is also possible to uniformly use the maximum overhead time.

In this embodiment, the maximum overhead time is specified, and the total of the maximum overhead time and the third transmission time are taken to be the required time in the applied case.

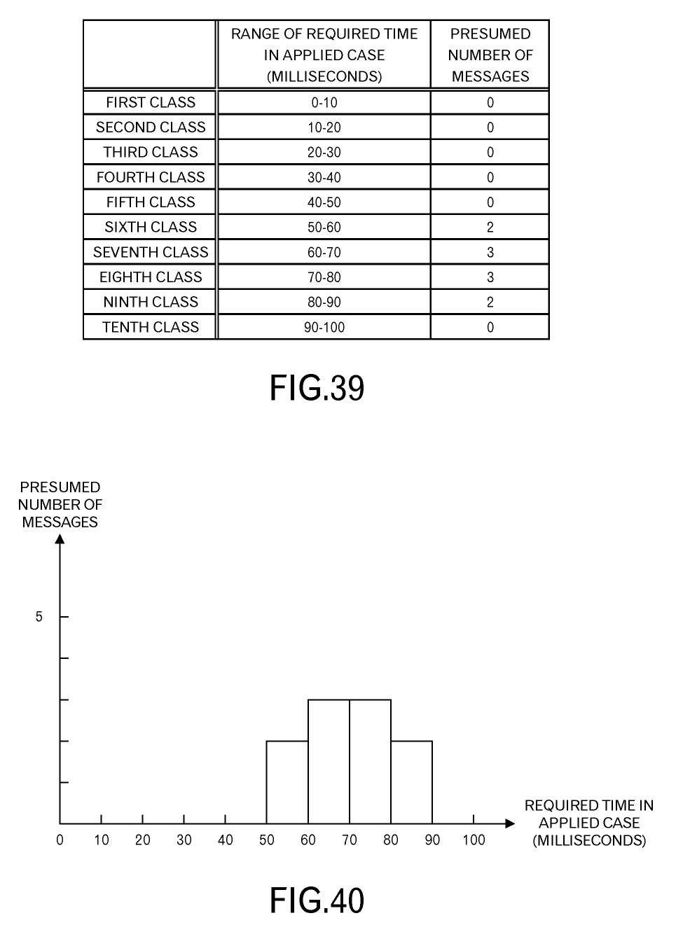

A fifth frequency distribution table that is illustrated in FIG. 39 represents the frequency distribution of the required time in the applied case in this embodiment. In this example, the maximum overhead time is taken to be 25 milliseconds. For each class in the frequency distribution of the third transmission time, 25 ms is added to the upper-limit value to specify the class corresponding to the frequency distribution of the required time in the applied case. Then, the fifth frequency distribution table is generated by shifting the frequency in the frequency distribution of the third transmission time to the frequency in the frequency distribution of the required time in the applied case.

A fifth histogram that is illustrated in FIG. 40 represents the frequency distribution of the required time in the applied case illustrated in FIG. 39.

As was described above, by comparing the frequency distribution of the required time in the applied case with the frequency distribution of the required time in the non-applied case, it is determined whether or not there is a strong tendency for shortening the required time by applying communication data conversion. Conventional techniques can be used as methods for comparing frequency distributions.

With this embodiment, it is possible to prevent the required time in the applied case from being estimated to be less than the actual required time.

### Embodiment 13

In the conversion processing of communication data described above, examples of performing data compression of chunks that are not cached were explained. However, it is also possible not to perform data compression of those chunks.

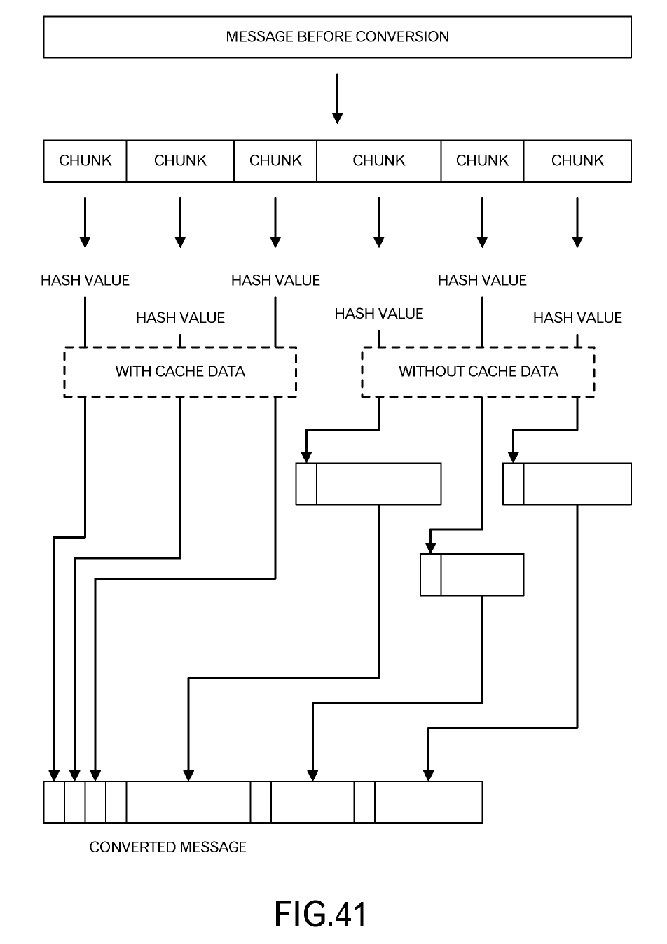

FIG. 41 illustrates an overview of the conversion processing of communication data in a thirteenth embodiment. When a message is divided into chunks and the chunks are cached, an index is added to a converted message as in the case illustrated in FIG. 3.

On the other hand, when a chunk is not cached, an index is added to the chunk as a header. When doing this, the compression processing is not performed on the chunk. Chunks to which headers are attached are added to the converted message.

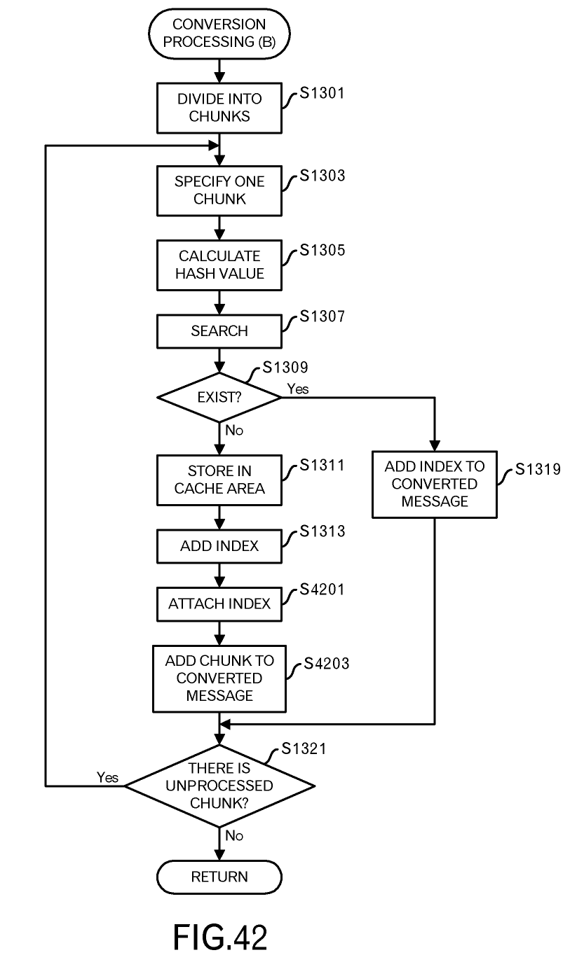

In this embodiment, conversion processing (B) is executed instead of the conversion processing (A) illustrated in FIG. 13. FIG. 42 illustrates a processing flow of the conversion processing (B). The processing illustrated by S1301 to S1313 is the same as in the case illustrated in FIG. 13.

Instead of the processing of S1315, the emulation unit 511 attaches an index as a header to the chunk (S4201). When doing this, data compression is not performed for the chunk.

The emulation unit 511 then adds the entire chunk with the header to the converted message (S4203).

The processing illustrated in S1319 to S1321 is the same as in the case illustrated in FIG. 13.

With this embodiment, it is possible to emulate the conversion processing even when the second relay apparatus 203 only performs the removal of duplication.

### Embodiment 14

In the embodiments described above, examples of removing duplication in the conversion processing were explained. However, it is also possible to perform only data compression without performing removal of duplication in the conversion processing.

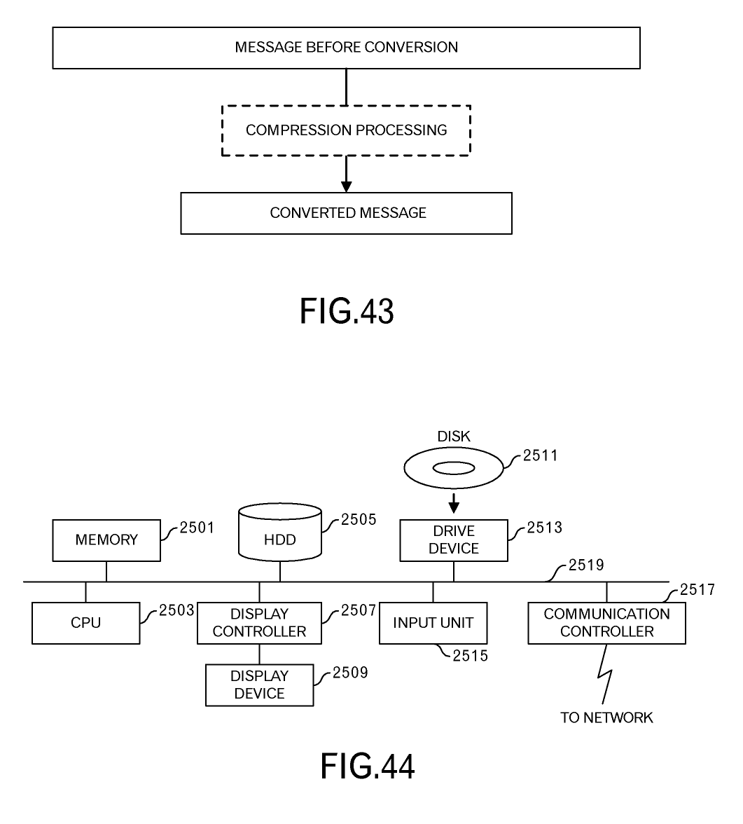

FIG. 43 illustrates an overview of the conversion processing for communication data in a fourteenth embodiment. In this embodiment, data compression is performed for an entire message before conversion without dividing the message into chunks. And the compressed data corresponds to the converted message.

With this embodiment, it is possible to emulate the conversion processing even when the second relay apparatus 203 only performs data compression.

Although the embodiments of this invention were explained above, this invention is not limited to those. For example, the functional block configuration which is explained above, does not always correspond to actual program module configuration.

Moreover, configuration of the aforementioned each storage area is a mere example, and may be changed. Furthermore, as for the processing flow, as long as the processing results do not change, the turns of the steps may be exchanged or the steps may be executed in parallel.

In addition, the aforementioned verification apparatus 401 is a computer device as illustrated in FIG. 44. That is, a memory 2501 (storage device), a CPU 2503 (central processing unit) that is a hardware processor, a HDD (hard disk drive) 2505, a display controller 2507 connected to a display device 2509, a drive device 2513 for a removable disk 2511, an input unit 2515, and a communication controller 2517 for connection with a network are connected through a bus 2519 as illustrated in FIG. 44. An OS (operating system) and an application program for carrying out the foregoing processing in the embodiments, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform predetermined operations. Moreover, intermediate processing data is stored in the memory 2501, and if necessary, it is stored in the HDD 2505. In these embodiments of this technique, the application program to realize the aforementioned processing is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer apparatus as stated above, the hardware such as the CPU 2503 and the memory 2501, the OS and the application programs systematically cooperate with each other, so that various functions as described above in details are realized.

The aforementioned embodiments are summarized as follows:

A verification method related to embodiments includes: (A) capturing communication data transmitted to a first site, from a node apparatus that is in a second site and is assumed to be connected to a conversion apparatus that performs conversion of communication data; (B) emulating the conversion of the captured communication data; (C) measuring a conversion time required for the conversion of the captured communication data; (D) calculating a first transmission time in a case where the captured communication data is assumed to be transmitted from the node apparatus to the conversion apparatus; (E) calculating a second transmission time in a case where converted communication data is assumed to be transmitted from the conversion apparatus to the node apparatus; (F) calculating a third transmission time in a case where the converted communication data is assumed to be transmitted from the node apparatus to the first site; (G) calculating a fourth transmission time in a case where the captured communication data is assumed to be transmitted from the node apparatus to the first site; and (H) determining an effect in a case where the conversion of the captured communication data by the conversion apparatus is applied, based on the first transmission time, the conversion time, the second transmission time, the third transmission time and the fourth transmission time.

By performing processing as described above, it becomes possible to verify the effect in a case where communication data conversion is applied in a system that is in operation. Accordingly, there is an aspect in which work for switching transmission paths is reduced. Moreover, there is also an aspect in which operation of the system is not prevented.

Moreover, the determining may include determining the effect for a predetermined service identified by a combination of a transmission source IP address and a transmission source port number, which are set in the captured communication data.

By performing processing as described above, it becomes possible to verify the effect in a case where the communication data conversion is applied, as for communication data transmitted from a specific service.

Moreover, the determining may include determining the effect for a predetermined session identified by a combination of a transmission source IP address, a transmission source port number, a transmission destination IP address and a transmission destination port number, which are set in the captured communication data.

By performing processing as described above, it becomes possible to verify the effect in a case where the communication data conversion is applied, as for communication data transmitted in a specific session.

Moreover, the verification method may further include: calculating a reduction rate of the captured communication data, the reduction rate being a rate of reduction caused by the conversion of the captured communication data. And the determining may include determining the effect further based on the reduction rate.

By performing processing as described above, it becomes possible to verify an effect of reduction of communication data. For example, it helps to estimate the effect of reduction of a communication cost.

Incidentally, it is possible to create a program causing a computer to execute the aforementioned processing, and such a program is stored in a computer readable storage medium or storage device such as a flexible dish, CD-ROM, DVD-ROM, magneto-optic disk, a semiconductor memory, and hard dish. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A non-transitory computer-readable recording medium storing a verification program that causes a computer to execute a process comprising:
capturing communication data transmitted to a first site, from a node apparatus that is in a second site and is assumed to be connected to a conversion apparatus that performs conversion of communication data;
emulating the conversion of the captured communication data;
measuring a conversion time required for the conversion of the captured communication data;
calculating a first transmission time in a case where the captured communication data is assumed to be transmitted from the node apparatus to the conversion apparatus;
calculating a second transmission time in a case where converted communication data is assumed to be transmitted from the conversion apparatus to the node apparatus;
calculating a third transmission time in a case where the converted communication data is assumed to be transmitted from the node apparatus to the first site;
calculating a fourth transmission time in a case where the captured communication data is assumed to be transmitted from the node apparatus to the first site; and
determining an effect in a case where the conversion of the captured communication data by the conversion apparatus is applied, based on the first transmission time, the conversion time, the second transmission time, the third transmission time and the fourth transmission time.

2. The non-transitory computer-readable recording medium as set forth in claim 1, wherein the determining comprises determining the effect for a predetermined service identified by a combination of a transmission source IP address and a transmission source port number, which are set in the captured communication data.

3. The non-transitory computer-readable recording medium as set forth in claim 1, wherein the determining comprises determining the effect for a predetermined session identified by a combination of a transmission source IP address, a transmission source port number, a transmission destination IP address arid a transmission destination port number, which are set in the captured communication data.

4. The non-transitory computer-readable recording medium as set forth in claim 1, further comprising:
calculating a reduction rate of the captured communication data, the reduction rate being a rate of reduction caused by the conversion of the captured communication data, and
wherein the determining comprises determining the effect further based on the reduction rate.

5. A verification method comprising:
capturing, by using a computer, communication data transmitted to a first site, from a node apparatus that is in a second site and is assumed to be connected to a conversion apparatus that performs conversion of communication data;
emulating, by using the computer, the conversion of the captured communication data;
measuring, by using the computer, a conversion time required for the conversion of the captured communication data;
calculating, by using the computer, a first transmission time in a case where the captured communication data is assumed to be transmitted from the node apparatus to the conversion apparatus;
calculating, by using the computer, a second transmission time in a case where converted communication data is assumed to be transmitted from the conversion apparatus to the node apparatus;
calculating, by using the computer, a third transmission time in a case where the converted communication data is assumed to be transmitted from the node apparatus to the first site;
calculating, by using the computer, a fourth transmission time in a case where the captured communication data is assumed to be transmitted from the node apparatus to the first site; and
determining, by using the computer, an effect in a case where the conversion of the captured communication data by the conversion apparatus is applied, based on the first transmission time, the conversion time, the second transmission time, the third transmission time and the fourth transmission time.

6. A verification apparatus, comprising:
a memory; and
a processor coupled to the memory and configured to:
capture communication data transmitted to a first site, from a node apparatus that is in a second site and is assumed to be connected to a conversion apparatus that performs conversion of communication data;
emulate the conversion of the captured communication data;
measure a conversion time required for the conversion of the captured communication data;
calculate a first transmission time in a case where the captured communication data is assumed to be transmitted from the node apparatus to the conversion apparatus;
calculate a second transmission time in a case where converted communication data is assumed to be transmitted from the conversion apparatus to the node apparatus;
calculate a third transmission time in a case where the converted communication data is assumed to be transmitted from the node apparatus to the first site;
calculate a fourth transmission time in a case where the captured communication data is assumed to be transmitted from the node apparatus to the first site; and
determine an effect in a case where the conversion of the captured communication data by the conversion apparatus is applied, based on the first transmission time, the conversion time, the second transmission time, the third transmission time and the fourth transmission time.
